(19) United States
(12) Patent Application Publication
(10) Pub. No.: US 2013/0154492 A1
(43) Pub. Date: Jun. 20, 2013

(54) Improvements relating rectifier circuits

(71) Applicant: David Summerland, Leicestershire (GB)

(72) Inventor: David Summerland, Leicestershire (GB)

(73) Assignee: HOLDIP Limited, Douglas (GB)

(21) Appl. No.: 13/544,928

(22) Filed: Jul. 9, 2012

Related U.S. Application Data
(63) Continuation of application No. PCT/GB2011/050020, filed on Jan. 7, 2011.

(30) Foreign Application Priority Data
Jan. 8, 2010 (GB) 1000250.9
Jan. 26, 2010 (GB) 1001221.9
Mar. 15, 2010 (GB) 1004248.9

(51) Int. Cl. H02M 7/06; H05B 33/08

(52) U.S. Cl. CPC H02M 7/06; H05B 33/0809
USPC 315/200 R; 363/126

(57) ABSTRACT

A rectifier circuit is disclosed comprising input terminals adapted to receive an alternating current voltage, and output terminals adapted to provide an output having a rectified output voltage. The rectifier circuit has a diode bridge in which the diodes are each adapted to be by-passed by a low-impedance path on activation of an associated electronic switching device (Q1,Q2,Q3,Q4). Furthermore, the rectifier circuit is adapted to control activation of one or more electronic switching devices (Q1,Q2,Q3,Q4), such that the flow of current relative to one of the output terminals is in one direction only.

### CROSS-REFERENCE TO RELATED APPLICATIONS

This application is a continuation of and claims priority to PCT/GB2011/050020, filed Jul. 14, 2011, which claims priority to United Kingdom application no. 1000250.9, filed Jan. 8, 2010; United Kingdom application no. 1001221.9, filed Jan. 26, 2010; and United Kingdom application no. 1004248.9, filed Mar. 15, 2010. Priority to and benefit of each of these prior applications is hereby claimed.

This invention relates to rectifier circuits, and in particular to rectifier circuits for use in power supplies.

Rectifier circuits are used to convert an AC input voltage to a DC output voltage, usually using one or more diodes. In particular, a common circuit for achieving full-wave rectification of an AC input voltage is a diode bridge.

A disadvantage of a conventional diode bridge is that there is a forward voltage drop (V_{f}) of two diodes between the input and the output of the rectifier circuit. With conventional silicon diodes, this voltage drop is likely to be at least around 1.5-3.0V. Even with more expensive Schottky diodes, the voltage drop is likely to be around 0.3-0.9V.

Rectifier circuits are commonly used in power supplies, and this voltage drop would result in a loss of power between the input and the output of the power supply. In particular, where a power supply is adapted to power a low voltage load, such as one or more LEDs, the voltage drop caused by a conventional diode bridge may result in a significant loss of efficiency.

Synchronous rectifier circuits address this problem by providing electronic switching devices that by-pass one or more of the diodes in the diode bridge with a low impedance path, when the current is flowing in the desired direction for producing a rectified output. Another form of circuit that addresses this problem is an active rectifier, in which the diodes are replaced by electronic switching devices, such as MOSFETs, and control circuitry activates the electronic switching devices to provide a rectified output. However, conventional synchronous rectifier circuits and active rectifier circuits are not entirely satisfactory. In particular, conventional circuits suffer from a number of disadvantages including complex and expensive control arrangements, switching devices going out of sync causing short circuits, discharging of output capacitors, and switching devices only being suitable for use with low voltages.

There have now been devised improved rectifier circuits and power adaptors which overcome or substantially mitigate the above-mentioned and/or other disadvantages associated with the prior art.

According to a first aspect of the invention, there is provided a rectifier circuit comprising
input terminals adapted to receive an alternating current voltage, and
output terminals adapted to provide an output having a rectified output voltage,
the rectifier comprising a diode bridge in which the diodes are each adapted to be by-passed by a low-impedance path on activation of an associated electronic switching device,
wherein the rectifier circuit is adapted to control activation of one or more electronic switching devices, such that the flow of current relative to one of the output terminals is in one direction only.

The rectifier circuit according to this aspect of the invention is advantageous principally because the arrangement of electronic switching devices provides rectification with a greater efficiency than a conventional diode bridge, and a capacitor may be provided across the first and second output terminals, without the capacitor being discharged through any of the electronic switching devices of the rectifier circuit. In addition, the rectifier circuit does not require prior knowledge of the form of the input in order to provide efficient transfer of power from the input to the output, without the risk of damaging short-circuit conditions.

The rectifier bridge preferably has a full bridge configuration. In particular, each diode of the diode bridge is preferably defined by the intrinsic body diode of an electronic switching device, such as a MOSFET, such that first and second electronic switching devices having first and second diodes are connected to a first output terminal, and third and fourth electronic switching devices having third and fourth diodes are connected to a second output terminal. Where the electronic switching devices are MOSFETs, this arrangement results in the MOSFETs being connected in the opposite direction to the normal connection arrangement of a MOSFET.

In a particular embodiment, the rectifier circuit comprises
first and second input terminals for receiving an alternating current voltage,
first and second output terminals for providing a rectified output voltage,
a first diode connected between the first input terminal and the first output terminal, the first diode either being included in a first electronic switching device or being connected in parallel with a first electronic switching device,
a second diode connected between the second input terminal and the first output terminal, the second diode either being included in a second electronic switching device or being connected in parallel with a second electronic switching device,
a third diode connected between the second input terminal and the second output terminal, the third diode either being included in a third electronic switching device or being connected in parallel with a third electronic switching device, and
a fourth diode connected between the first input terminal and the second output terminal, the fourth diode either being included in a fourth electronic switching device or being connected in parallel with a fourth electronic switching device,
the diodes of the first and second electronic switching devices enabling the flow of current in the direction from the connected input terminal to the connected output terminal, and the diodes of the third and fourth electronic switching devices enabling the flow of current in the direction from the connected output terminal to the connected input terminal,
each electronic switching device being adapted to present a low impedance path between the connected terminals when the electronic switching device is activated, and
the rectifier circuit being adapted to actively control at least some of the electronic switching devices to provide a rectified output.

A simple arrangement for achieving synchronisation between the current direction, and the activation of the electronic switching devices, comprises the gate connections of the first and fourth electronic switching devices being connected to the second input terminal, and the gate connections of the second and third electronic switching devices being connected to the first input terminal.

The connections between the gate connections of the electronic switching devices and the respective input terminals may be direct connections, or may be connections via a control circuit. In particular, the rectifier circuit may include a control module, which receives a signal from the input terminals that triggers an activation signal from the control module that is provided to the gate connection of the respective electronic switching device. In particular, the control module preferably senses the voltage at the input to the rectifier circuit using Schmitt trigger logic.

The electronic switching devices preferably include integrated diodes, which are bypassed by a low impedance path when the electronic switching device is activated. The electronic switching devices currently available with these properties are enhancement mode MOSFETs, which include intrinsic body diodes. Hence, in presently preferred embodiments, the first electronic switching device is preferably a p-channel MOSFET having a drain connected to the first input terminal and a source connected to the first output terminal, the second electronic switching device is preferably a p-channel MOSFET having a drain connected to the second input terminal and a source connected to the first output terminal, the third electronic switching device is an n-channel MOSFET having a drain connected to the second input terminal and a source connected to the second output terminal, the fourth electronic switching device is an n-channel MOSFET having a drain connected to the first input terminal and a source connected to the second output terminal.

At least some of the electronic switching devices may be controlled by timed activation, for example by means of a monostable circuit that provides a one-shot timed waveform to the gate connections of the electronic switching devices. In presently preferred embodiments, a first pair of switching devices (either the first and second switching devices, or the third and fourth switching devices) is controlled by timed activation, and the other pair of switching devices is controlled by a direct connection to an input terminal. In view of p-channel MOSFETs having a higher gate voltage, and a general desire to provide a simple control arrangement, it is presently preferred that the n-channel MOSFETS (the third and fourth switching devices) are controlled by timed activation, and the p-channel MOSFETs are controlled by direct connections to an input terminal.

At least some of the MOSFETs may be selected to have a low gate capacitance, in order to ensure a short charging period, which is preferably of the order of nanoseconds, in order to minimise the period during which a voltage drop is present across the intrinsic body diodes of the MOSFETs, and a voltage drop is present between the gate connection and the connected input terminal, and hence maximise efficiency.

At least some of the MOSFETs may be selected to have a gate-source breakdown voltage that is greater than the voltages that the rectifier circuit is intended to receive at its input. However, where the rectifier circuit is intended to receive voltages that are greater than the gate-source breakdown voltages of any of the MOSFETs, the rectifier circuit may be adapted to provide a potential difference between the gate connection and the connected input terminal, for at least some of the electronic switching devices, substantially only during the charging of the capacitance of the electronic switching device.

According to a further aspect of the invention, there is provided a rectifier circuit comprising
input terminals adapted to receive an alternating current voltage, and
output terminals adapted to provide an output having a rectified output voltage,
the rectifier comprising a diode bridge in which the diodes are each adapted to be by-passed by a low-impedance path on activation of an associated electronic switching device,
wherein the rectifier circuit is adapted to provide a potential difference between a gate connection of the electronic switching device and a connected input terminal that controls activation of the electronic switching device, for at least some of the electronic switching devices, substantially only during the charging of the capacitance of the electronic switching device.

This arrangement is advantageous principally because the rectifier circuit may be adapted to receive input voltages in excess of the breakdown voltages of the electronic switching devices, without significantly reducing the efficiency of the rectifier circuit

In this arrangement, the rectifier circuit may include means for limiting the potential difference provided between the gate connection and the connected input terminal to a pre-determined maximum. For example, the potential difference provided between the gate connection and the connected input terminal may be substantially constant, for example at a pre-determined voltage, during charging of the capacitor of the electronic switching device. In these embodiments, the rectifier circuit may be adapted to receive voltages up to the sum of the lowest breakdown voltage of the electronic switching devices, and the potential difference provided between the gate connection and the connected input terminal during charging of the capacitor of that electronic switching device. For example, enhancement mode MOSFETs typically have a gate-source breakdown voltage of around 18-20V. Hence, provision of a substantially constant 12V potential difference between the gate connection of each MOSFET and the connected input terminal would enable the rectifier circuit to receive input voltages up to 30-32V.

In one embodiment, the means for providing a substantially constant potential difference between the gate connection and the connected input terminal, during charging of the capacitor of the electronic switching device, comprises a diode clamp, eg a zener diode. In particular, a zener diode may be connected between the gate connection and the connected input terminal. Alternatively, a zener diode may be connected in parallel to the gate connection, with the gate connection AC coupled to the respective input terminal. Where the gate connection of the electronic switching device is connected to a logic gate arrangement, the input voltage to the logic gate arrangement is preferably limited, for example using a diode clamping circuit, and the logic gate arrangement and the connected input terminal are preferably AC coupled.

The rectifier circuits described above are particularly suitable for use in the supply of power to a solid state light source, such as one or more LEDs, for example as an output stage of a power adaptor for a solid state light source. In this application, and indeed in many other applications, it is preferable to smooth the DC output, for example to reduce the peak current. Hence, a capacitor may be provided across the first and second output terminals, and the circuit may include a means for preventing discharge of the capacitor through any of the electronic switching devices of the rectifier circuit.

The discharge preventing means may be a diode, most preferably with a low forward voltage drop, such as a Schottky diode. Although the inclusion of a diode would introduce a voltage drop into the rectifier circuit, this voltage drop would be across one diode only, rather than across two diodes, as would be the case in a conventional diode bridge. Furthermore, only one relatively expensive Schottky diode would be needed for high efficiency, rather than the four needed for an efficient diode bridge, thereby significantly reducing manufacturing costs. As an alternative, the diode could be replaced by a single synchronous rectifier, which may comprise a MOSFET that is turned on when current is flowing into the output capacitor, but turned off when current is flowing in the other direction.

Alternatively, the rectifier circuit may comprise only first and second electronic switching devices, and a first diode connected between the second input terminal and the second output terminal, and a second diode connected between the first input terminal and the second output terminal, where the first and second diodes enable the flow of current in the opposite direction between the connected input and output terminals relative to the flow of current enabled by the first and second electronic switching devices. In effect, the third and fourth electronic switching devices discussed above have each been replaced by a diode, which are preferably diodes with a low forward voltage drop, such as Schottky diodes. This arrangement removes the need for a diode at the output of the rectifier circuit, and reduces the forward voltage drop from a voltage drop across two electronic switching devices and a diode to a voltage drop across one electronic switching device and a diode.

A further alternative for preventing discharge of the output capacitor through any of the electronic switching devices of the rectifier circuit is to provide a circuit that activates one or more electronic switching devices to allow flow of current relative to at least one of the output terminals in one direction only.

The one or more electronic switching devices that are controlled in order to ensure that the flow of current relative to one of the output terminals is in one direction only, may be an additional electronic switching device, in addition to the one or more electronic switching devices that by-pass the one or more diodes with a low-impedance path. In these embodiments, only one electronic switching device would need to be controlled, even for a full diode bridge, and hence the control circuit may be much simpler. However, an additional switching device would be required.

Alternatively, the one or more electronic switching devices that are controlled in order to ensure that the flow of current relative to one of the output terminals is in one direction only, may be electronic switching devices that by-pass the one or more diodes with a low-impedance path. In particular, in a full bridge arrangement, the rectifier circuit is preferably adapted to control activation of two of the electronic switching devices that are connected to the same output terminal, such that the flow of current relative to that output terminal is in one direction only.

The rectifier circuit is preferably adapted to provide timed activation of two of the electronic switching devices, the two electronic switching devices being connected to the same output terminal, to allow flow of current relative to that output terminal in one direction only. The other two electronic switching devices may also be connected to a timed activation circuit, but in presently preferred embodiments are activated by signals received directly from the input terminals, as discussed above, such that only one half of the rectifier bridge is activated using a timing circuit.

The timed activation is preferably adapted to allow flow of current through the electronic switching devices in one direction only. The timed activation is preferably provided by an activation waveform that is provided to the gate connections of the electronic switching devices. For example, the timed activation circuit is preferably a monostable circuit that provides a one-shot timed waveform to the gate connections of the electronic switching devices.

The timed activation is preferably triggered by a connection to an input terminal, eg using a Schmitt trigger. The rectifier circuit preferably includes a logic gate arrangement that determines when each of the associated electronic switching devices is to be activated, and may enable a single timed activation circuit to activate two electronic switching devices.

As discussed above, the provision of a potential difference between the gate connection and the connected input terminal, for each electronic switching device, substantially only during the charging of the capacitor of the electronic switching device, enables the rectifier circuit to receive input voltages in excess of the breakdown voltages of the electronic switching devices, without significantly reducing the efficiency of the rectifier circuit. However, the rectifier circuit may also include a low voltage configuration, in which the potential difference between the gate connection of each electronic switching device and the connected input terminal is removed.

In presently preferred embodiments, the rectifier circuit enables connection of a low impedance path between the gate connection of each electronic switching device and the connected input terminal, in order to by-pass the means for providing a potential difference between the gate connection of each electronic switching device and the connected input terminal, eg by-passing the zener diodes.

The rectifier circuit may have the form of an integrated circuit, such that the first and second input terminals, and the first and second output terminals, of the rectifier circuit are each defined by a pin of the integrated circuit.

The integrated circuit may enable a low impedance path to be defined between the gate connection of each electronic switching device and the connected input terminal, in order to by-pass the means for providing a potential difference between the gate connection of each electronic switching device and the connected input terminal, and hence put the rectifier circuit in a low voltage configuration. In particular, the integrated circuit may include a control pin for the gate connection of each electronic switch, which is adapted to be connected to an input terminal in order to define the low impedance path between the gate connection of the electronic switching device and the connected input terminal.

The rectifier circuit and the integrated circuit discussed above are particularly suitable for use in a power adaptor, for providing power to a load. Hence, according to a further aspect of the invention, there is provided a power adaptor comprising a rectifier circuit as described above.

The power adaptor may comprise an input for connection to a mains power supply, and an LCL series-parallel resonant circuit coupled to the input that provides an output suitable for driving a load. This configuration of power adaptor is particularly advantageous in relation to the powering of solid state light sources, as described in WO 2008/120019.

According to a further aspect of the invention, there is provided a power adaptor comprising an input for connection to an AC power supply, an LCL series-parallel resonant circuit, and a rectifier circuit as described therein adapted to receive an alternating current voltage from the LCL series-parallel resonant circuit and provide an output having a rectified output voltage that is suitable for driving a load.

By “LCL series-parallel resonant circuit” is meant a resonant circuit comprising a first inductor and a first capacitor in series, and a parallel load leg including a second inductor. The first inductor and first capacitor are preferably connected in series between two input terminals of the resonant circuit, and the resonant circuit preferably comprises a load leg connected in parallel across the first capacitor, wherein the load leg comprises the second inductor and an output for driving the load, which are connected in series. In particular, the LCL resonant circuit preferably has input terminals and output terminals with a first inductor L1, connected from a first input terminal through a common point with second inductor L2, to a first output terminal, the second input terminal being directly connected to the second output terminal, and a capacitor C1, connected between the common point between the two inductors and the direct connections between second terminals of input and output. The input terminals are preferably adapted to be driven from a high frequency inverter. Any of the first inductor, the first capacitor and the second inductor may comprise a single inductive or capacitive component or a combination of such components.

The resonant circuit is preferably adapted such that at one of its resonant frequencies, the power adaptor provides a constant current output, at a given effective input voltage, and the resonant circuit is preferably driven at that resonant frequency or a sub-harmonic thereof, or sufficiently near to that resonant frequency or a sub-harmonic thereof for the power adaptor to be suitable for use with a constant current load, such as a solid state light source. In particular, the first and second inductors are preferably selected such that the reactance X_{L1} of the first inductor and the reactance X_{L2} of the second inductor are substantially equal in magnitude, and are substantially equal in magnitude to the reactance X_{C1} of the first capacitor. In particular, X_{L1}≈X_{L2}≈−X_{C1} in presently preferred embodiments.

When the chosen components satisfy these conditions, at a given input voltage, the current delivered to a load will be constant, independent of the load connected to the power adapter. Furthermore, variation of the input voltage would directly control the magnitude of the constant current delivered to the load. When driving a constant voltage load, such as LEDs, the power delivered to the load would therefore be directly proportional to the input voltage, without requiring any feedforward or feedback control.

The LCL series-parallel resonant circuit is particularly advantageous in relation to the power adaptor according to the invention because the LCL series-parallel resonant circuit may be adapted to provide a constant current output, and hence the rectifier circuit would be protected from peak currents that could cause damage to the circuit when converting the AC output of the LCL series-parallel resonant circuit to a DC output. Indeed, this feature of the LCL series-parallel resonant circuit would enable low current electronic switching devices (eg MOSFETs) to be used in the rectifier circuit, thereby reducing manufacturing costs. The LCL series-parallel resonant circuit may also be unaffected by any short periods during which the input to the rectifier circuit is shorted, for example during start-up.

The LCL series-parallel resonant circuit inherently boosts the input voltage during the valleys of the mains waveform (as discussed in WO 2008/120019), such that the voltage at the input terminals of the rectifier circuit has a substantially constant amplitude, thereby ensuring that the rectifier circuit is working substantially throughout each mains cycle. In addition, the resonant frequency of the LCL series-parallel resonant circuit does not vary with input voltage, unlike the LC resonant circuit, and hence active control of the electronic switching devices is more feasible.

Furthermore, in this configuration, it is desirable to provide a capacitance at the output of the resonant circuit in order to reduce conducted emissions when driving solid state light sources, such as LEDs, and hence the gate capacitances of the MOSFETs of the rectifier circuit are preferably selected to provide at least some of this capacitance at the output of the resonant circuit. In present preferred embodiments, the gate capacitances of the electronic switching devices, eg MOSFETs, of the rectifier circuit are selected to be substantially equal to, or less than, the capacitance at the output of the resonant circuit that would reduce conducted emissions. Hence, the rectifier circuit replaces some, or all, of the output capacitor that would otherwise be needed in order to reduce conducted emissions when driving solid state light sources. The capacitance of the MOSFETs would therefore provide no additional losses in this configuration.

It has also been found that a short-circuit across the input terminals of the rectifier circuit does not have any negative effect on the LCL series-parallel resonant circuit, due to the constant current output of the resonant circuit and the lack of any potential difference between the output terminals of the resonant circuit in this configuration. Hence, the power adaptor may include a controller that activates at least some of the electronic switching devices to create a short-circuit condition in the rectifier circuit.

According to a further aspect of the invention, there is provided a rectifier circuit having
input terminals adapted to receive an alternating current voltage, and
output terminals adapted to provide an output having a rectified output voltage,
the rectifier comprising a diode bridge in which the diodes are each adapted to be by-passed by a low-impedance path on activation of an associated electronic switching device,
wherein the rectifier circuit is adapted to activate at least some of the electronic switching devices to control the power provided at the output terminals.

The rectifier circuit is preferably adapted to create a short-circuit across the input terminals of the rectifier circuit in at least part of the input cycle, such that the power provided at the output terminals is reduced or removed.

This arrangement for reducing or removing the power at the output terminals is particularly advantageous when used with an LCL series-parallel resonant circuit because the power adaptor is protected from high peak voltages in the mains input, without directly controlling the LCL resonant circuit, which may result in significant efficiency losses and/or RFI problems. In addition, since the output of the LCL resonant circuit is not turned off, the input of the power adaptor will continue to draw current from the mains, which helps maintain the current drawn by the resonant circuit when driven by an external TRIAC. There is also no noticeable increase in light flicker, and this arrangement helps maintain harmonic compliance and good power factor.

According to a further aspect of the invention, there is provided a power adaptor comprising an input for connection to an AC power supply, an LCL series-parallel resonant circuit, and a rectifier circuit as described above.

The short-circuit across the input terminals of the rectifier circuit may be present in both half-cycles of the input to the rectifier circuit, which would cause the output to fall to zero, or it may be present in only one half-cycle of the input to the rectifier circuit, which would cause the output to fall to approximately 50% of full power. Alternatively, a controller may be provided that controls the output of the rectifier circuit using a modulated activation of at least some of the electronic switching devices to create modulated short-circuits across the input terminals of the rectifier circuit.

The rectifier circuits according to the invention preferably include a full-bridge rectifier circuit, as described above. In particular, the rectifier circuit preferably includes a diode bridge, where each diode is defined by the intrinsic body diode of an electronic switching device, such as a MOSFET, such that first and second electronic switching devices having first and second diodes are connected to a first output terminal, and third and fourth electronic switching devices having third and fourth diodes are connected to a second output terminal. In this arrangement, the first and second switching devices are p-channel MOSFETs, and the third and fourth MOSFETs are n-channel MOSFETs. The implementation of this aspect of the invention to a full-bridge rectifier circuit, as described above, is discussed in more detail below.

When it is desired to provide a short-circuit across the input terminals of the rectifier circuit in both half-cycles of the input to the rectifier circuit, which would cause the output to fall to zero, the rectifier circuit is preferably adapted to activate two of the switching devices that are connected to the same output terminal, and different input terminals, and keep these switching devices activated to maintain the short-circuit condition. In addition, the rectifier circuit is preferably adapted to simultaneously deactivate the switching devices that are connected to the other output terminal, and keep these switching devices deactivated while the short-circuit condition is present, in order to prevent the creation of a short-circuit across the output terminals of the rectifier circuit. In particular, the rectifier circuit may be adapted to activate either the first and second switching devices, or the third and fourth switching devices, and simultaneously deactivate the other two switching devices.

When it is desired to provide a short-circuit across the input terminals of the rectifier circuit in only one half-cycle of the input to the rectifier circuit, which would cause the output to fall to approximately 50% of full power, the rectifier circuit may be adapted to activate one of the switching devices, and keep this switching device activated during the half-cycle in which the other switching device that is connected to the same output terminal is activated, or its associated diode is conducting, in order to provide a short-circuit condition in one half-cycle. In this arrangement, the rectifier circuit is preferably adapted to simultaneously deactivate the switching device that is connected to the same input terminal, and keep this switching device deactivated while the short-circuit condition in one half-cycle is present, in order to prevent the creation of a short-circuit across the output terminals of the rectifier circuit. In order to ensure that the other half-cycle of the input to the rectifier circuit is transferred to the output terminals efficiently, the switching devices that are connected to the other input terminal are preferably activated, either by a direct gate connection or a control circuit, when current is following through the electronic switching devices in the direction required for the desired rectified output.

As discussed above, at least some of the electronic switching devices may be controlled by timed activation, for example by means of a monostable circuit that provides a one-shot timed waveform to the gate connections of the electronic switching devices. In presently preferred embodiments, the switching devices connected to one output terminal are controlled by timed activation, and the switching devices connected to the other output terminal are controlled by a direct connection to an input terminal. In view of p-channel MOSFETs having a higher gate voltage, and a general desire to provide a simple control arrangement, it is presently preferred that the n-channel MOSFETS are controlled by timed activation, and the p-channel MOSFETs are controlled by direct connections to an input terminal.

In this arrangement, the one or more electronic switching devices that are activated to create the short-circuit condition are preferably controlled by timed activation. In addition, the one or more electronic switching devices that are deactivated while the short-circuit condition is present, in order to prevent the creation of a short-circuit across the output terminals of the rectifier circuit, are preferably controlled by direct connections to an input terminal.

Where an electronic switching device that is controlled by a direct connection to an input terminal is provided, and it is desired to deactivate that switching device using the control module, for example to achieve the short-circuit conditions discussed above, the rectifier circuit is preferably adapted to disable the direct connection to the input terminal to enable the control circuit to deactivate the switching device. This disablement means may comprise an electronic switching device in the direct connection, which is activated by the control module.

In the arrangement in which a short-circuit is provided across the input terminals of the rectifier circuit in only one half-cycle of the input to the rectifier circuit, which would cause the output to fall to approximately 50% of full power, the rectifier circuit is preferably adapted to provide efficient transfer of power in the half cycle in which the short-circuit condition is not present. In particular, the rectifier circuit is preferably adapted to activate the electronic switching device to provide a low impedance path in the half cycle in which the short-circuit condition is not present. This is most conveniently achieved by providing a direct connection between the switching device and the input terminal during at least the half cycle in which the short-circuit condition is not present.

The rectifier circuit may include a protection circuit that activates at least some of the electronic switching devices of the rectifier circuit, when a fault condition exists, to create a short-circuit across the input terminals of the rectifier circuit that reduces or removes the power provided at the output terminals, as discussed above. The fault condition may be an increase in a voltage above a pre-determined value. Alternatively, the fault condition may be an increase in other parameters, such as temperature, above a pre-determined value. The protection circuit may therefore be used to protect a device at the output, such as an LED, from overheating.

Since the short-circuit condition in the rectifier circuit will cause the input voltage to fall, the protection circuit preferably also includes an energy storage device that maintains the protection circuit in its activated state for a period of time, for example until the energy storage device has been discharged. The protection circuit may be adapted to deactivate, once the energy storage device has been discharged. If the fault condition has been removed, the rectifier circuit may be adapted to continue normal operation. However, if the fault condition is still present, the rectifier circuit may be adapted to reactivate, and continue to reactivate each time the energy storage device is discharged, until the fault condition is removed.

For example, since an open circuit condition would cause a catastrophic failure of an LCL series-parallel resonant circuit, and would also cause the voltage in the rectifier circuit to rise above normal operating voltages, the rectifier circuit preferably includes protection against an open circuit condition. In particular, the rectifier circuit is preferably adapted to detect any increase of the output voltage above a pre-determined voltage, and activate at least some of the electronic switching devices to create a short-circuit across the input terminals of the rectifier circuit that reduces or removes the power provided at the output terminals. In this application, the short-circuit across the input terminals of the rectifier circuit is preferably present in both half-cycles of the input to the rectifier circuit, such that the power provided at the output terminals is removed, ie falls to zero.

Similarly, the rectifier circuit may include a protection circuit that detects when the voltage at the input to a drive circuit, such as the LCL series-parallel resonant circuit discussed above, is above a pre-determined level, and activates at least some of the electronic switching devices to create a short-circuit across the input terminals of the rectifier circuit that reduces or removes the power provided at the output terminals. This protection circuit may be adapted to prevent damage to the load, at the output of the rectifier circuit. In this application, it may only be necessary for the short-circuit across the input terminals of the rectifier circuit to be present in one half-cycle of the input to the rectifier circuit, such that the power provided at the output terminals falls to approximately 50% of full power.

The 50% power mode may also be utilised to adapt the circuit for use with either 110V or 230V mains power.

The rectifier circuit preferably also includes a circuit for deactivating at least some of the electronic switching devices of the rectifier circuit, when the magnitude of the input voltage is below a particular level in each AC cycle, such that the rectifier circuit acts as a diode bridge.

According to a further aspect of the invention, there is provided a rectifier circuit having
input terminals adapted to receive an alternating current voltage, and
output terminals adapted to provide an output having a rectified output voltage,
the rectifier comprising one or more diodes that are adapted to be by-passed by a low-impedance path on activation of an associated electronic switching device,
wherein the rectifier circuit is adapted to deactivate at least some of the electronic switching devices of the rectifier circuit, when the magnitude of the voltage at the input terminals of the rectifier circuit is below a particular level in each AC cycle.

The rectifier circuit according to this aspect of the invention is advantageous principally because the rectifier circuit may be adapted to act as a diode bridge during those periods of the input cycle in which the magnitude of the voltage is below a particular level. This removes the risk that low, distorted input voltages will cause the electronic switching devices to become unsynchronised, and hence cause undesired short-circuit conditions in the rectifier circuit, such as shorts between the input and output terminals.

The rectifier circuit may be adapted to sense the magnitude of the voltage at the input terminals of the rectifier circuit, and deactivate at least some of the electronic switching devices when the magnitude of that voltage is below a pre-determined voltage in each AC input cycle. Alternatively, the rectifier circuit may include a connection to a drive circuit, eg a resonant circuit, such as the LCL series-parallel resonant circuit discussed above, that provides an AC input to the rectifier circuit, and deactivate at least some of the electronic switching devices when the magnitude of a voltage in the drive circuit is below a pre-determined voltage in each AC cycle. This voltage in the drive circuit may be at the input to the drive circuit, for example across one or more DC link capacitors of an LCL series-parallel resonant circuit.

This aspect of the invention is particularly advantageous in relation to power adaptors comprising resonant circuits. Hence, according to a further aspect of the invention, there is provided a power adaptor comprising an input for connection to an AC power supply, a resonant circuit, and a rectifier circuit as described above. The resonant circuit is preferably an LCL series-parallel resonant circuit.

Where a power adaptor comprises a resonant circuit and a rectifier, the problem of low, distorted input voltages being supplied to the rectifier circuit may also be addressed by maintaining the power output of the resonant circuit above a particular level, throughout the voltage cycle.

Hence, according to a further aspect of the invention, there is provided a power adaptor comprising an input for connection to an AC power supply, a resonant circuit, and a rectifier, the resonant circuit being coupled to the input and being adapted to provide an output to a rectifier, and the rectifier providing an output for driving a load, wherein the power adaptor includes an energy storage device adapted to provide supplementary power to the resonant circuit when the magnitude of the voltage received by the resonant circuit from the input of the power adaptor is below a pre-determined voltage.

The resonant circuit is preferably an LCL series-parallel resonant circuit, which may be driven by an oscillator that forms part of an integrated circuit, ie a controller.

The power adaptor according to this aspect of the invention is advantageous principally because the problem of low, distorted input voltages being supplied to the rectifier circuit may be removed. In addition, this arrangement may reduce current ripple at the output, and hence reduce light flicker when the power adaptor is used with a solid state light source, such as an LED.

In a particular arrangement, the energy storage device, such as a capacitor, is connected to the input of the resonant circuit by a diode, such that the energy storage device provides supplementary power to the resonant circuit when the magnitude of the voltage across the input to the resonant circuit, eg across the DC link capacitors, falls below the voltage across the energy storage device. This preferably has the effect of preventing the magnitude of the voltage across the input to the resonant circuit, eg across the DC link capacitors, from falling below the voltage across the energy storage device.

In presently preferred embodiments, the magnitude of the voltage across the input to the resonant circuit, eg across the DC link capacitors, does not fall below the voltage of the power supply to the controller of the resonant circuit. This arrangement ensures that the oscillations of the resonant circuit are stable, and not distorted.

The rectifier circuits described above typically require controlled activation of one or more electronic switching devices, in order to achieve a particular function. In this regard, it has been found to be particularly advantageous to provide an input stage that at least partially determines the form of the input to the diode bridge, wherein the input stage is driven and/or controlled by timing means that also control at least some of the electronic switching devices.

Since the same timing means is used to drive and/or control the input stage that at least partially determines the form of the input to the diode bridge, as well as control at least some of the electronic switching devices of the diode bridge, this enables the control of the electronic switching devices to be in time with the input to the diode bridge, without any need for a direct connection to the input of the diode bridge, or prediction of the form of the input to the diode bridge.

Hence, according to a further aspect of the invention, there is provided a circuit comprising
a diode bridge in which the diodes are each adapted to be by-passed by a low-impedance path on activation of an associated electronic switching device,
an input stage that at least partially determines the form of the input to the diode bridge, and
output terminals adapted to provide an output having a rectified output voltage,
wherein timing means are provided that drive and/or control both the input stage and activation of one or more of the electronic switching devices.

The timing means is preferably a clock of a processor, and the processor preferably drives and/or controls the input stage and the one or more electronic switching devices. The control of the one or more electronic switching devices may be as described above in relation to previous aspects of the invention, for example to provide protection, reduced power modes, etc, and may be based on one or more inputs to the timing means or processor, such as voltage, serial data, etc.

This aspect of the invention is particularly advantageous where the rectifier circuit forms part of a power adaptor, in which the input stage comprises a resonant circuit, eg an LCL series-parallel resonant circuit, such that the timing means drive and/or control both the resonant circuit and activation of one or more of the electronic switching devices. Hence, according to a further aspect of the invention, there is provided a power adaptor comprising a rectifier circuit as described above, wherein the input stage includes a resonant circuit that is driven by the timing means.

According to a further aspect of the invention, there is provided an integrated circuit comprising any one of the rectifier circuits described above.

According to a further aspect of the invention, there is provided a lighting system comprising any one of the power adaptors described above and a lighting unit including a solid state light source. The lighting unit will typically be provided with a plurality of solid state light sources.

According to a further aspect of the invention, there is provided a lighting unit suitable for direct connection to a mains supply, the lighting unit comprising any one of the power adaptors described above and a solid state light source. The lighting unit preferably comprises a housing for accommodating the power adaptor and the solid state light source, and a connector for connecting the input of the power adaptor to the mains supply.

Preferred embodiments of the invention will now be described in greater detail, by way of illustration only, with reference to the accompanying drawings, in which

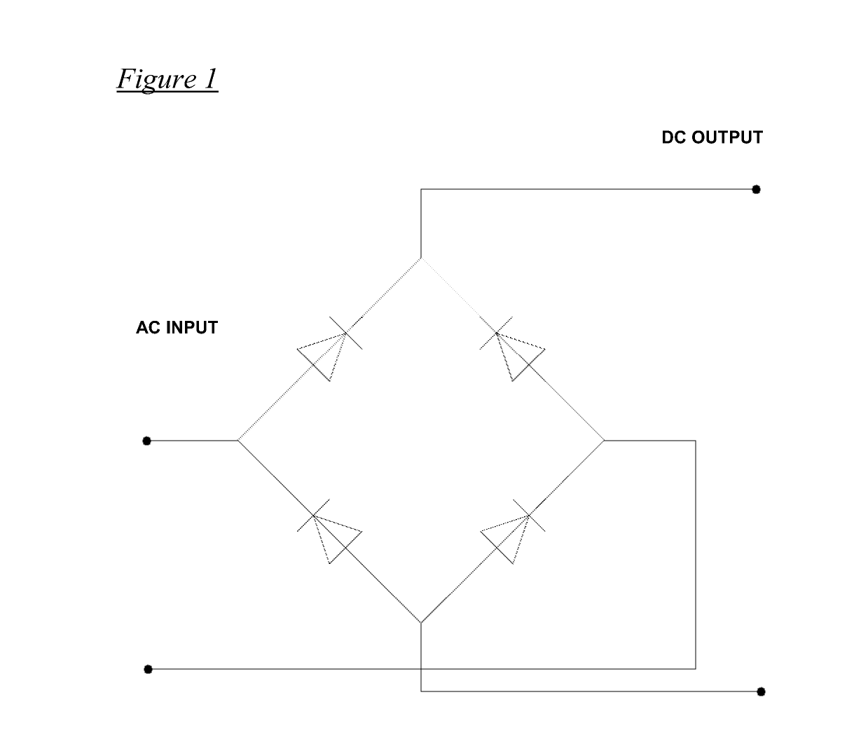

FIG. 1 is a conventional full-wave rectifier circuit consisting of a diode bridge;

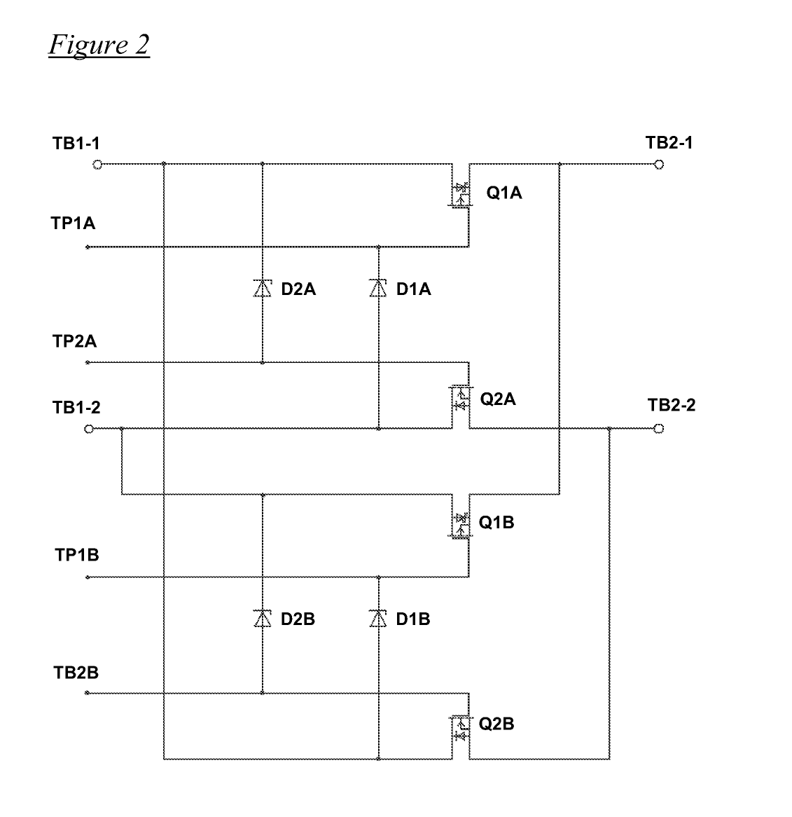

FIG. 2 is diagram of a rectifier circuit according to a first embodiment of the invention;

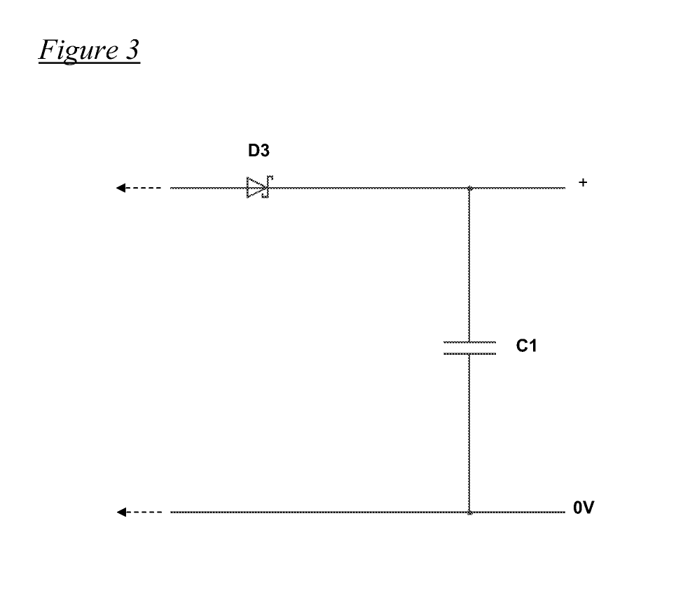

FIG. 3 is a diagram of an output circuit that, together with the circuit of FIG. 2, forms a rectifier circuit according to a second embodiment of the invention;

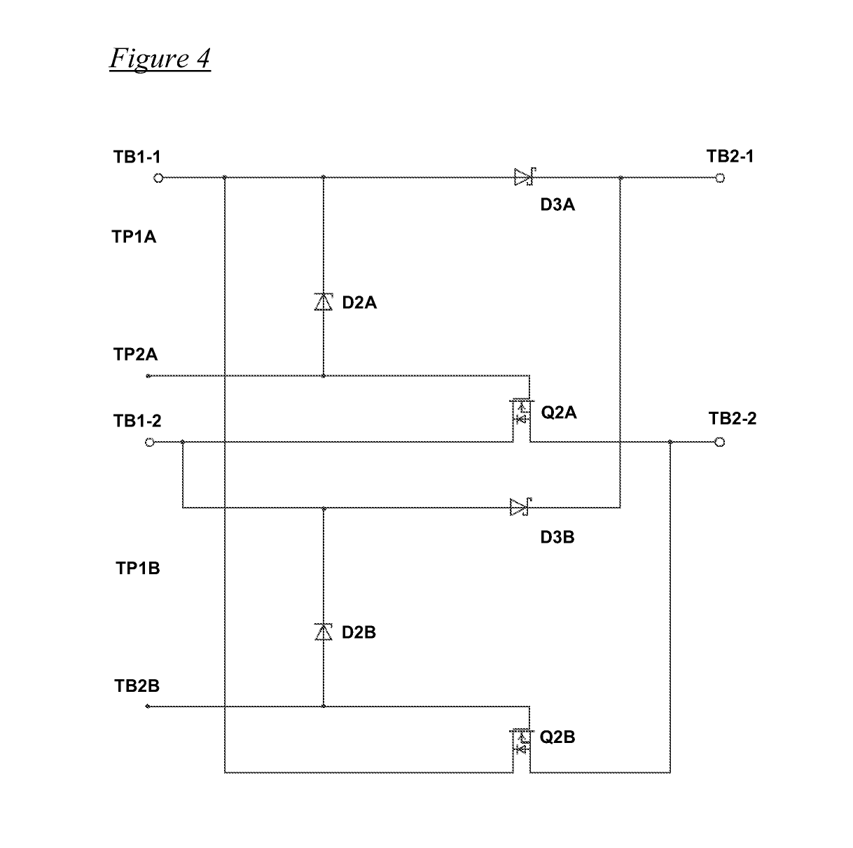

FIG. 4 is diagram of a rectifier circuit according to a third embodiment of the invention;

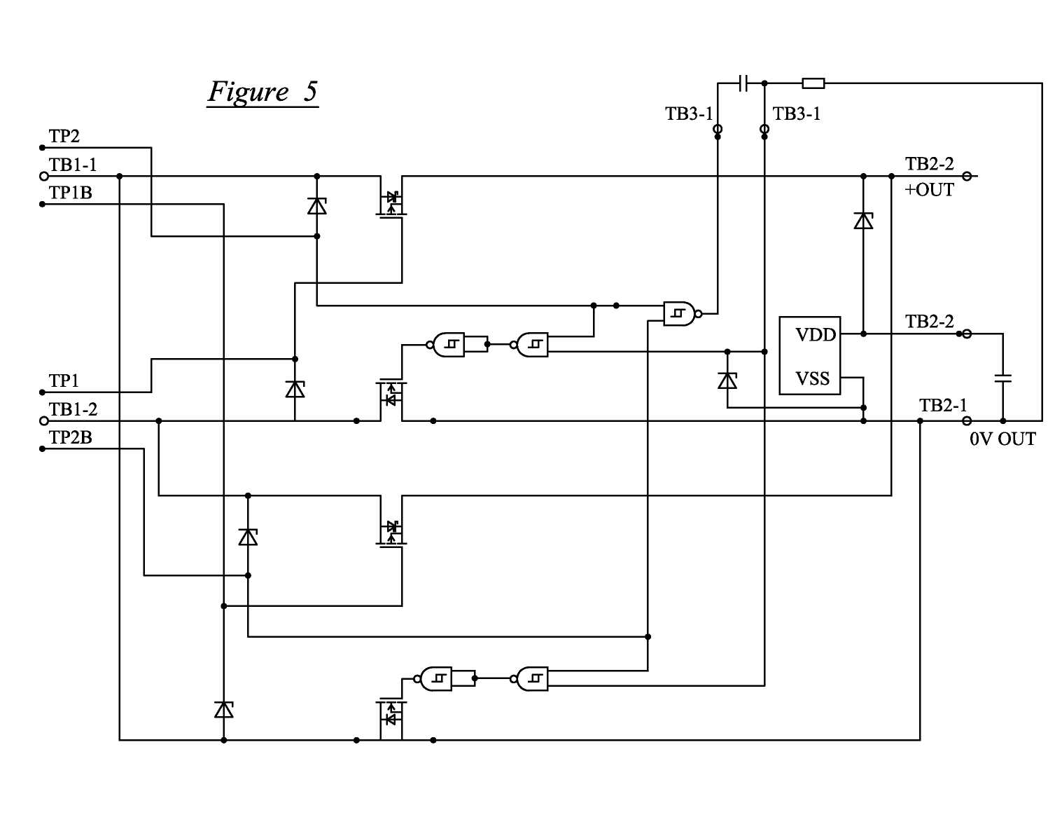

FIG. 5 is diagram of a rectifier circuit according to a fourth embodiment of the invention;

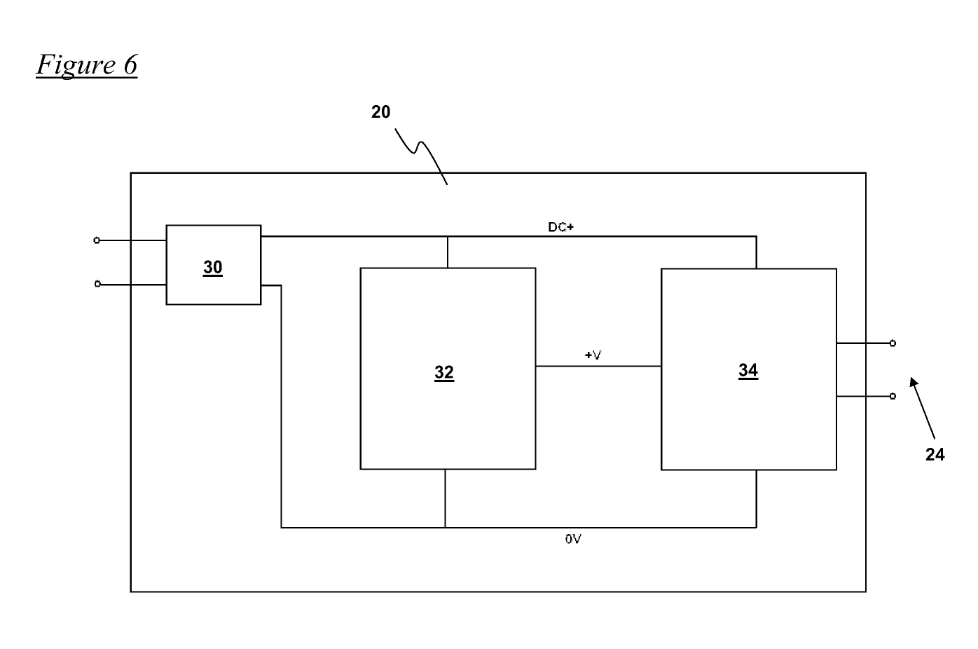

FIG. 6 is a schematic diagram of a first embodiment of a power adaptor according to the invention;

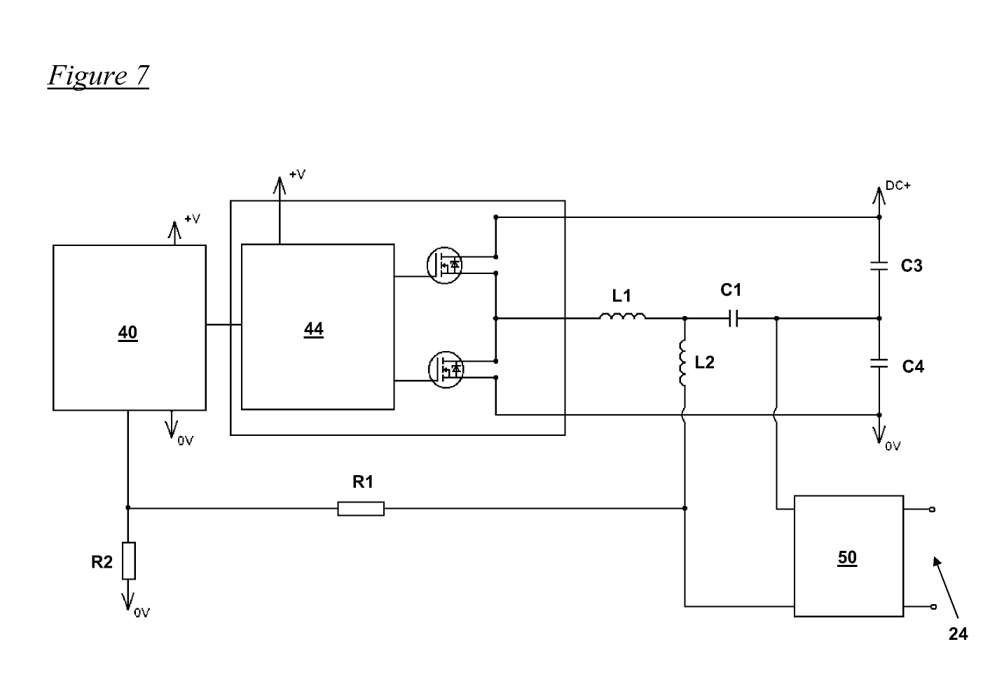

FIG. 7 is a schematic diagram of a resonant circuit, including a resonance controller and a resonance drive circuit, that forms part of the power adaptor of FIG. 6;

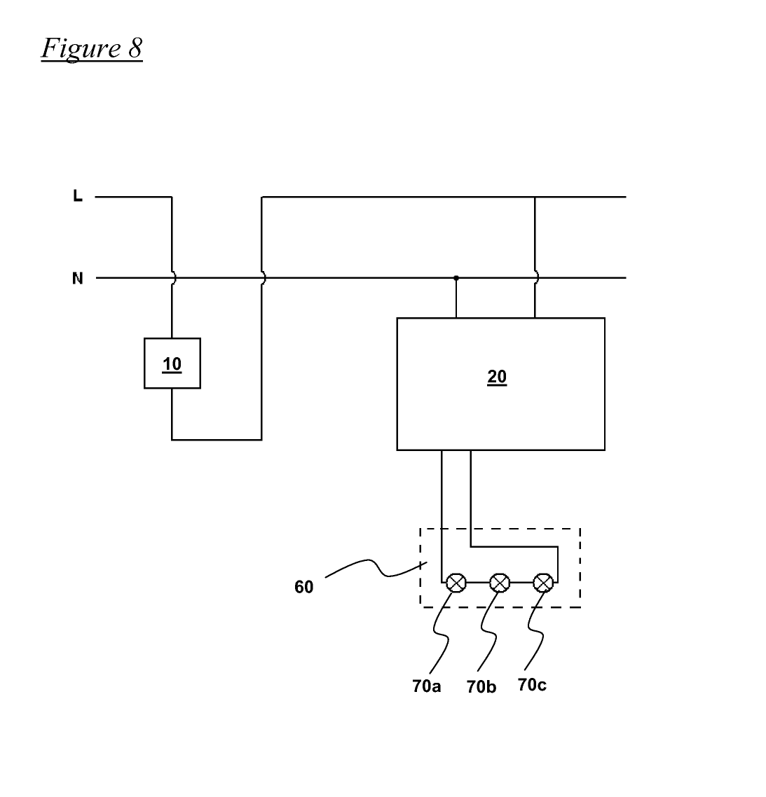

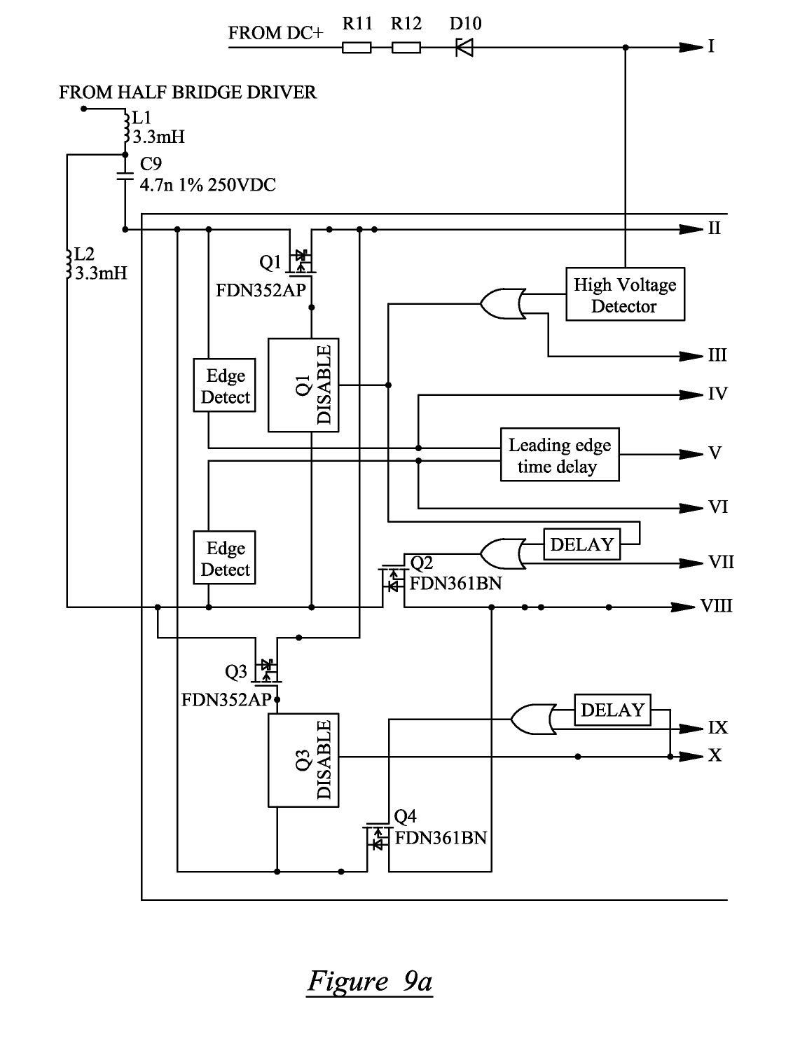

FIG. 8 is a schematic diagram of a lighting system according to the invention;

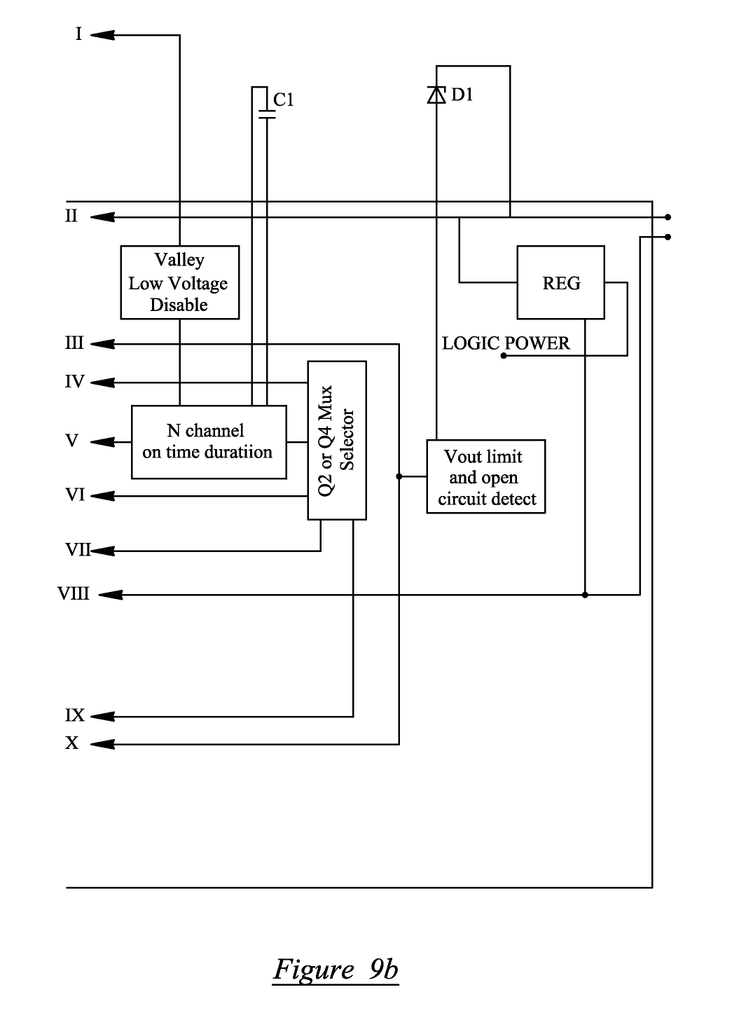

FIGS. 9a and 9b are schematic diagrams of a rectifier circuit according to a fifth embodiment of the invention;

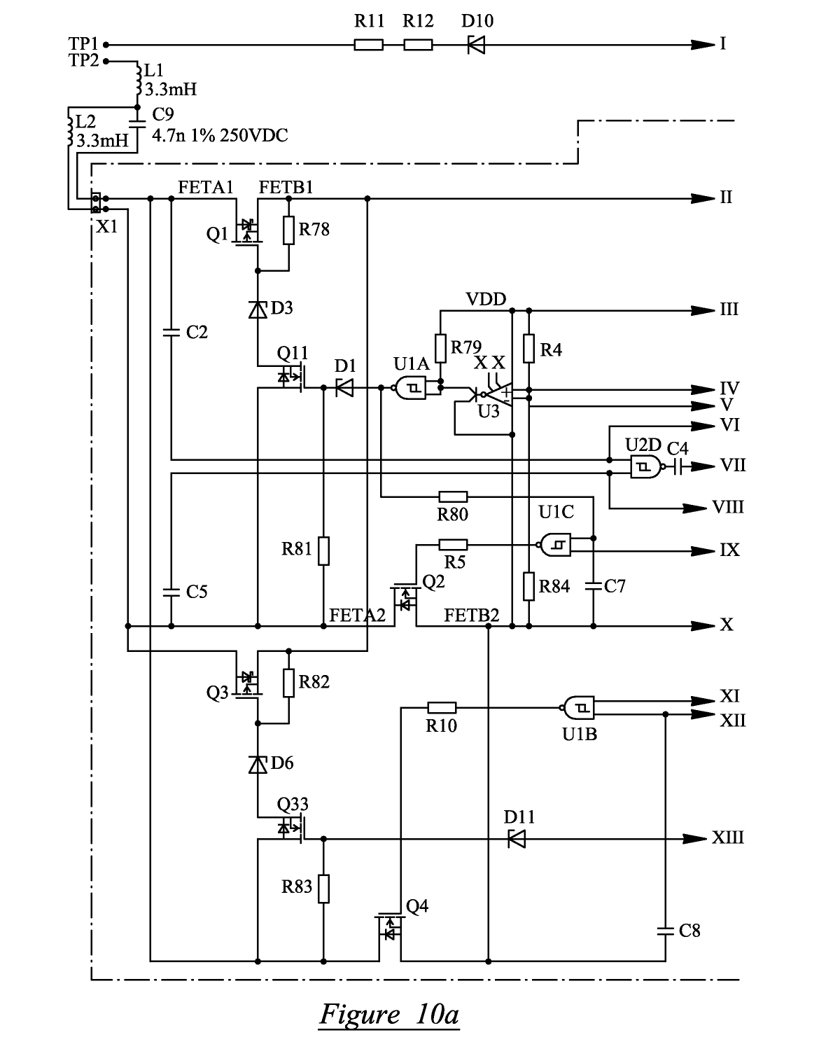

FIGS. 10a and 10b are circuit diagrams of the fifth embodiment of the invention;

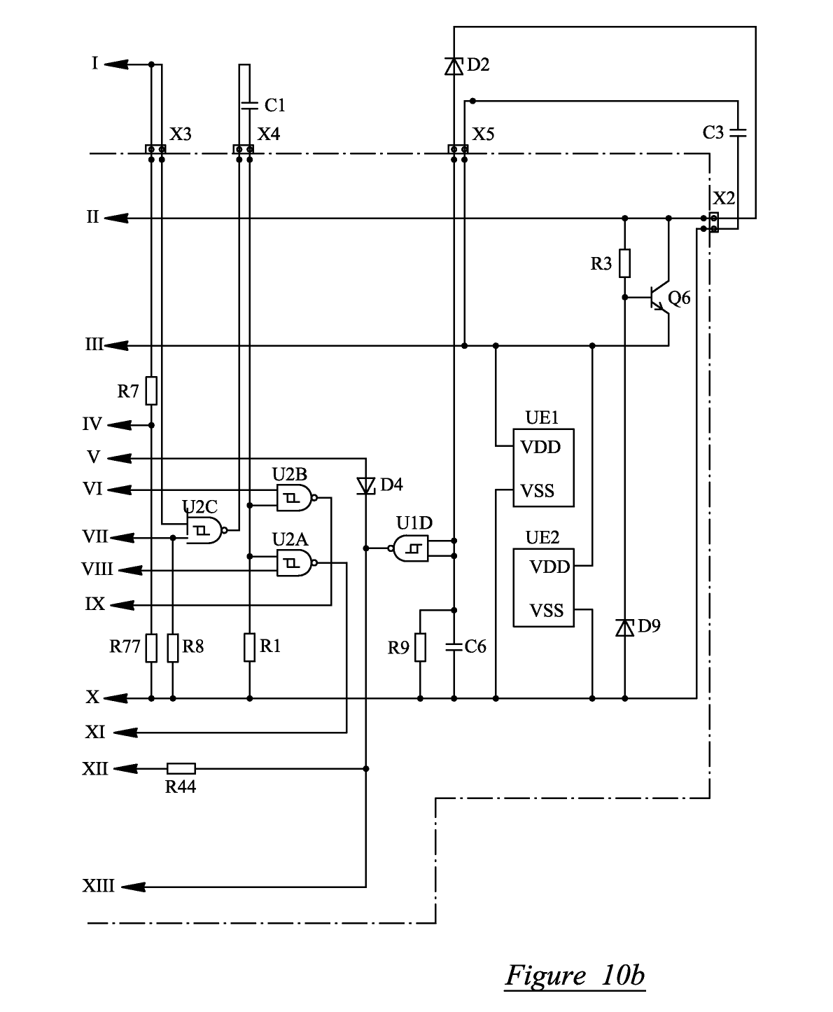

FIG. 11 is a schematic diagram of a second embodiment of a power adaptor according to the invention;

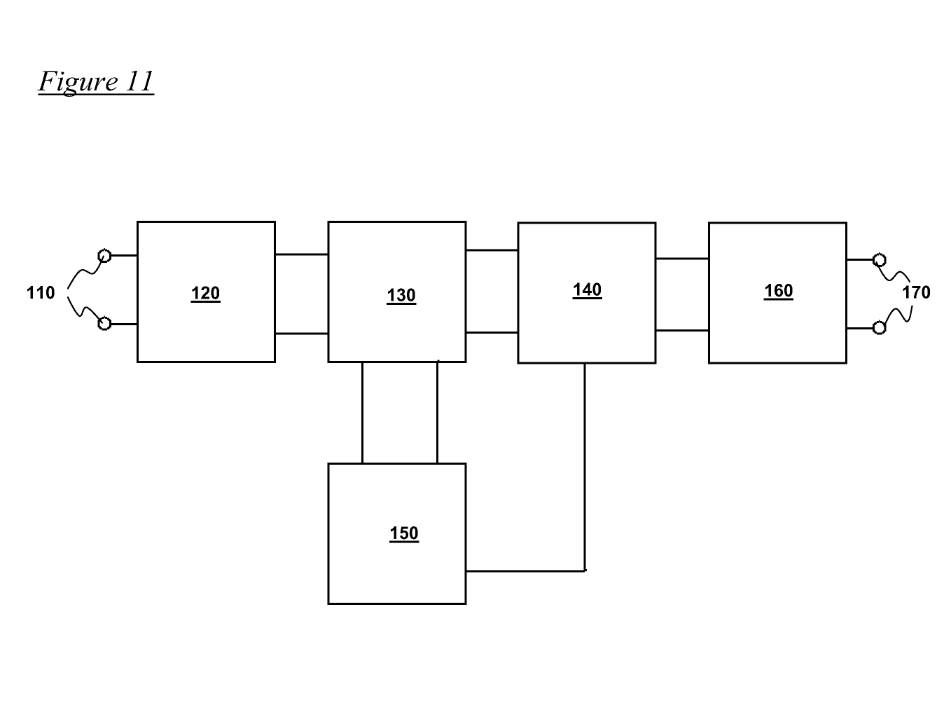

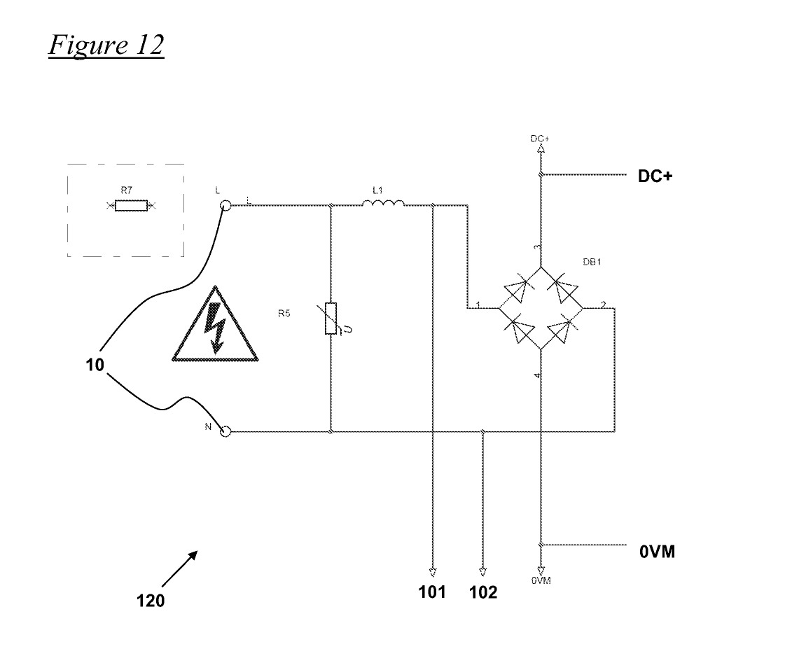

FIG. 12 is a diagram of an input rectifier of the power adaptor of FIG. 11;

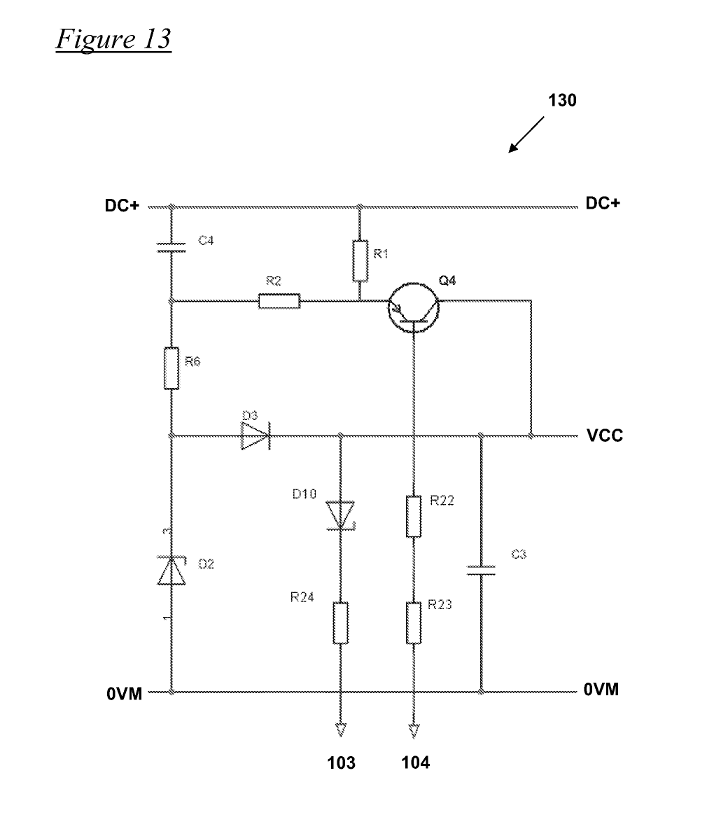

FIG. 13 is a diagram of a combined snubber and auxiliary supply of the power adaptor of FIG. 11;

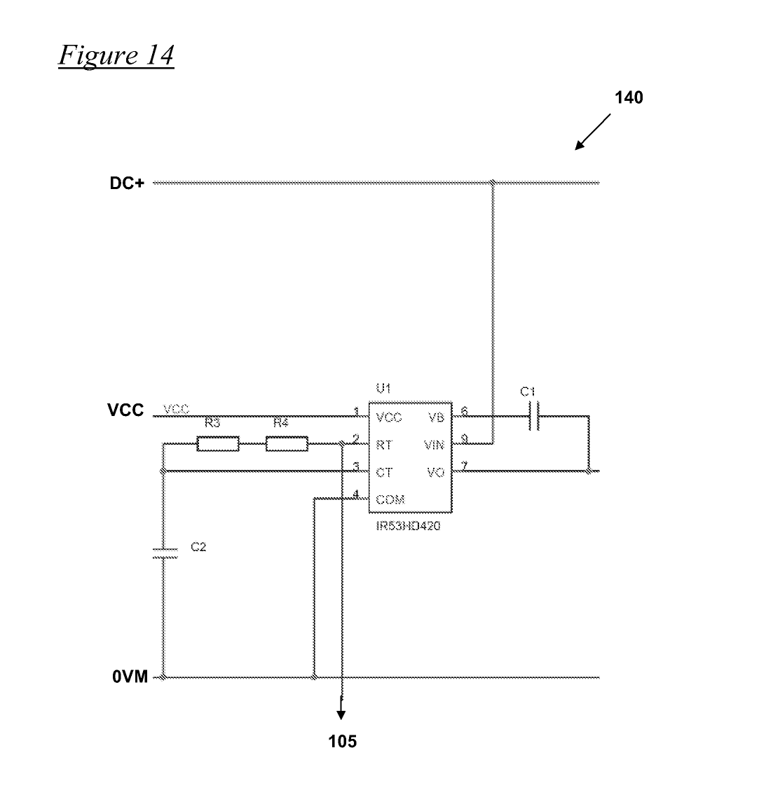

FIG. 14 is a diagram of a control circuit of the power adaptor of FIG. 11;

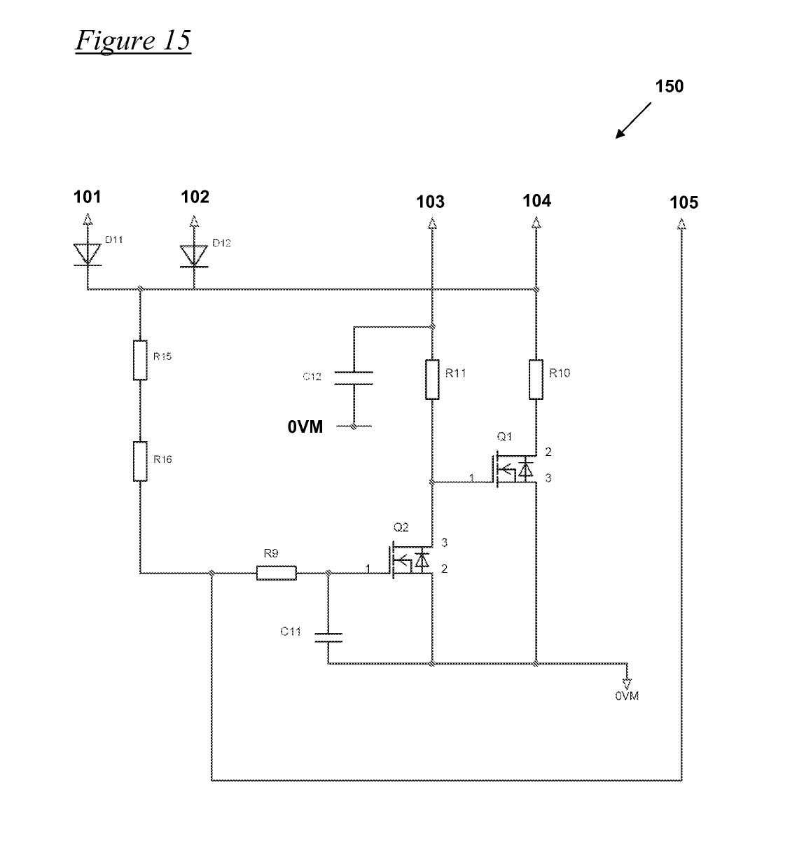

FIG. 15 a diagram of a discharge circuit of the power adaptor of FIG. 11;

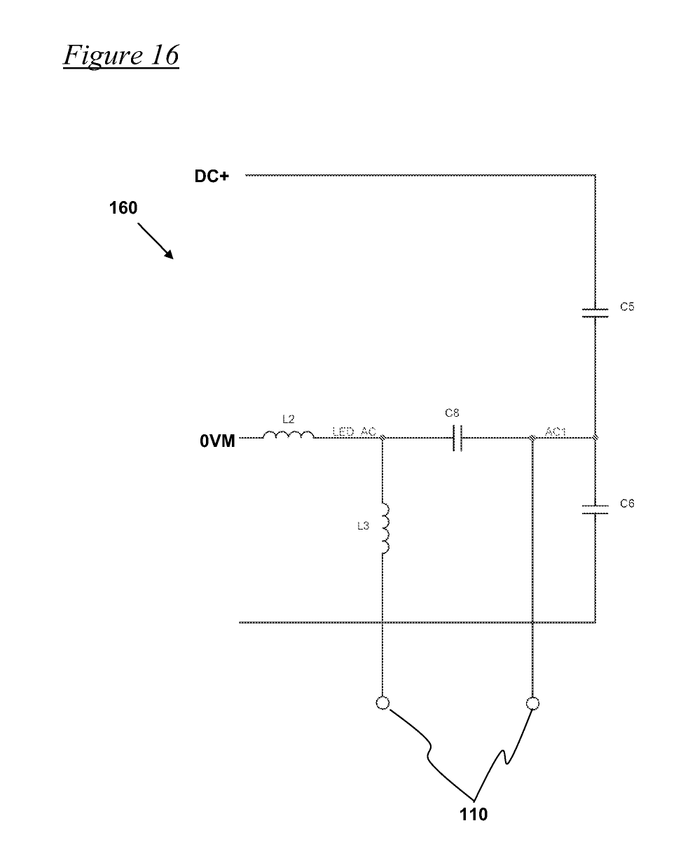

FIG. 16 is a diagram of a drive circuit of the power adaptor of FIG. 11;

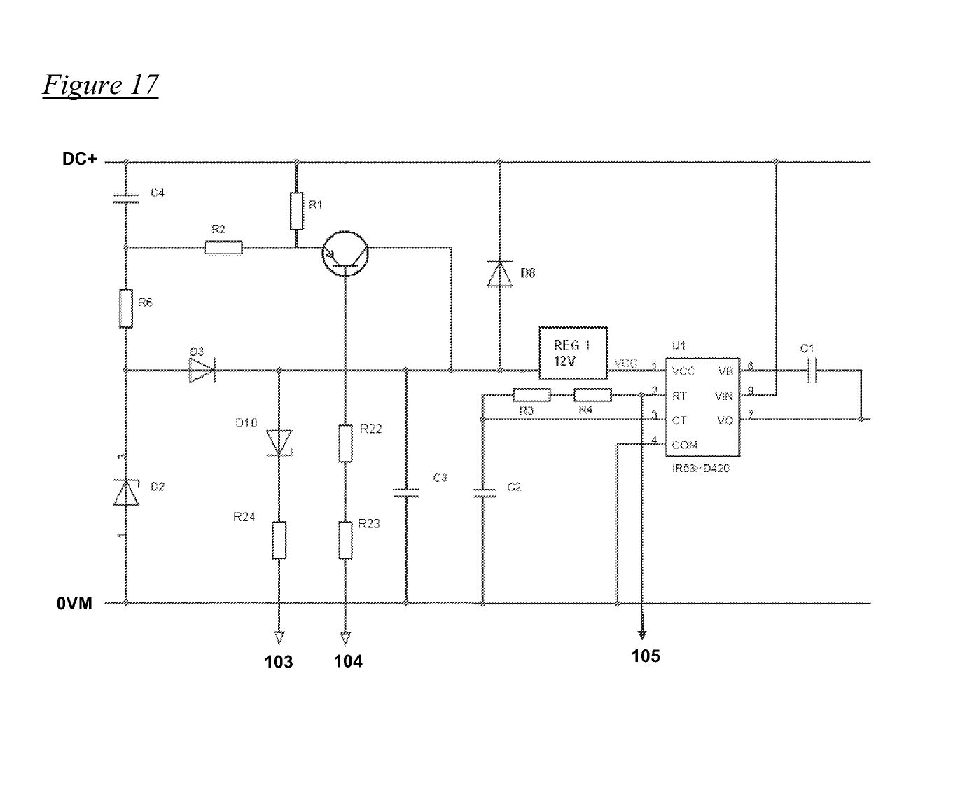

FIG. 17 is a diagram of an alternative combined snubber and auxiliary supply, and a control circuit, for use with the power adaptor of FIG. 11;

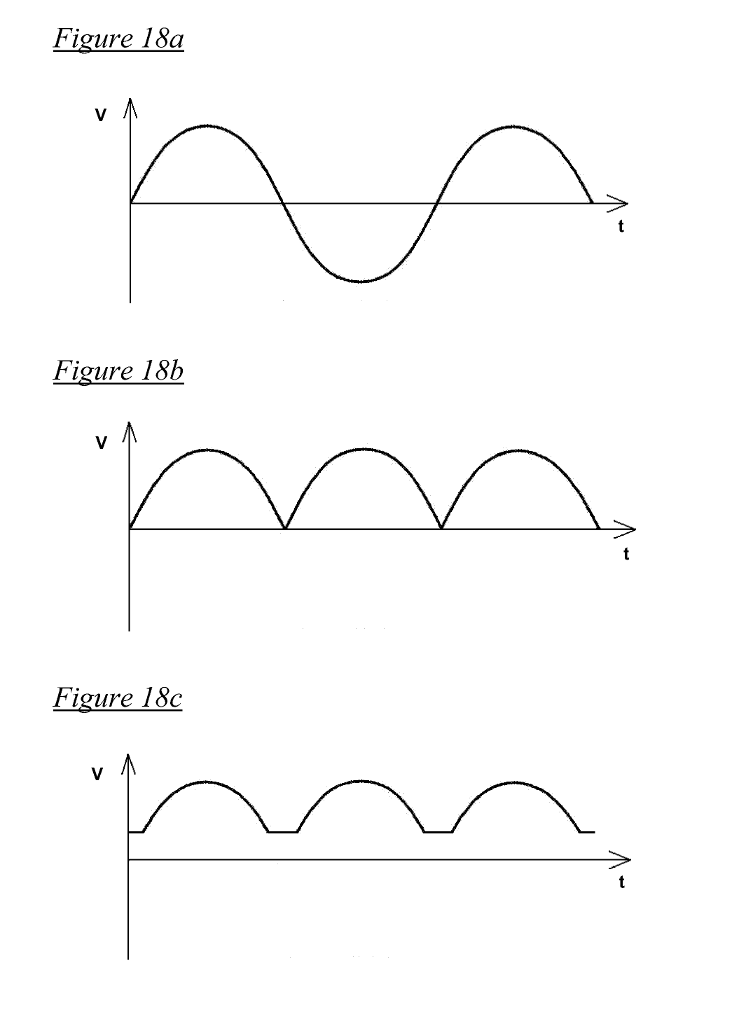

FIGS. 18a, 18b and 18c are schematic illustrations of an idealised mains input current (FIG. 18a), an idealised output current of a power adaptor of FIG. 11 (FIG. 18b), and an idealised output current of the power adaptor of FIG. 11 when modified in accordance with the arrangement shown in FIG. 17 (FIG. 18c);

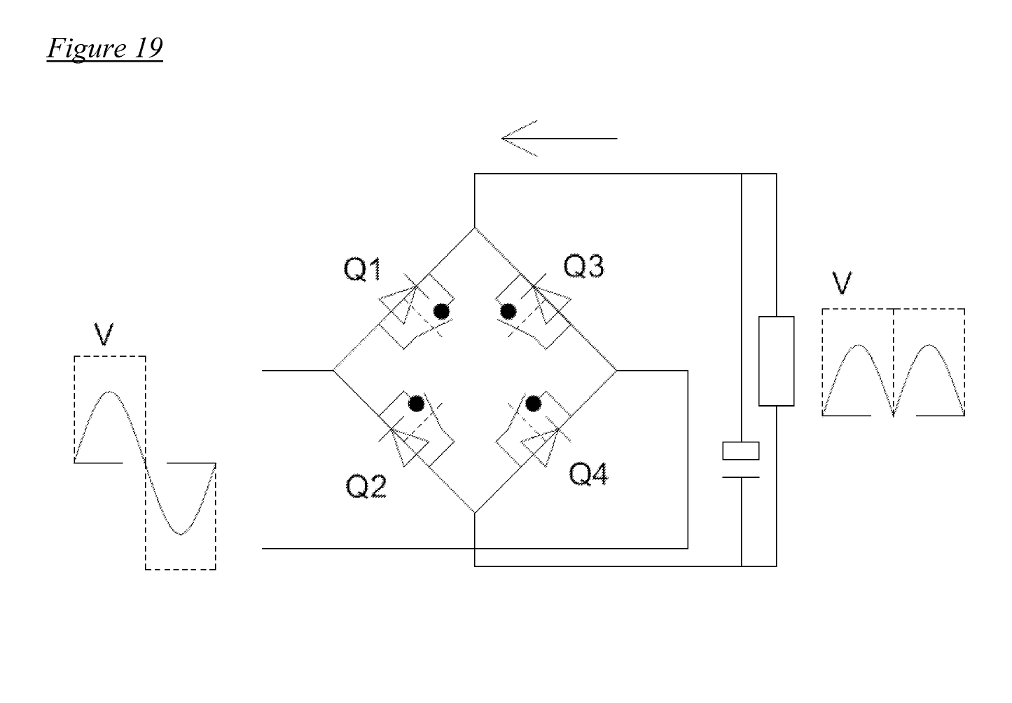

FIG. 19 is a schematic illustration of a rectifier circuit in which each MOSFET is controlled by a direct connection to an input terminal, eg the circuit of FIG. 2;

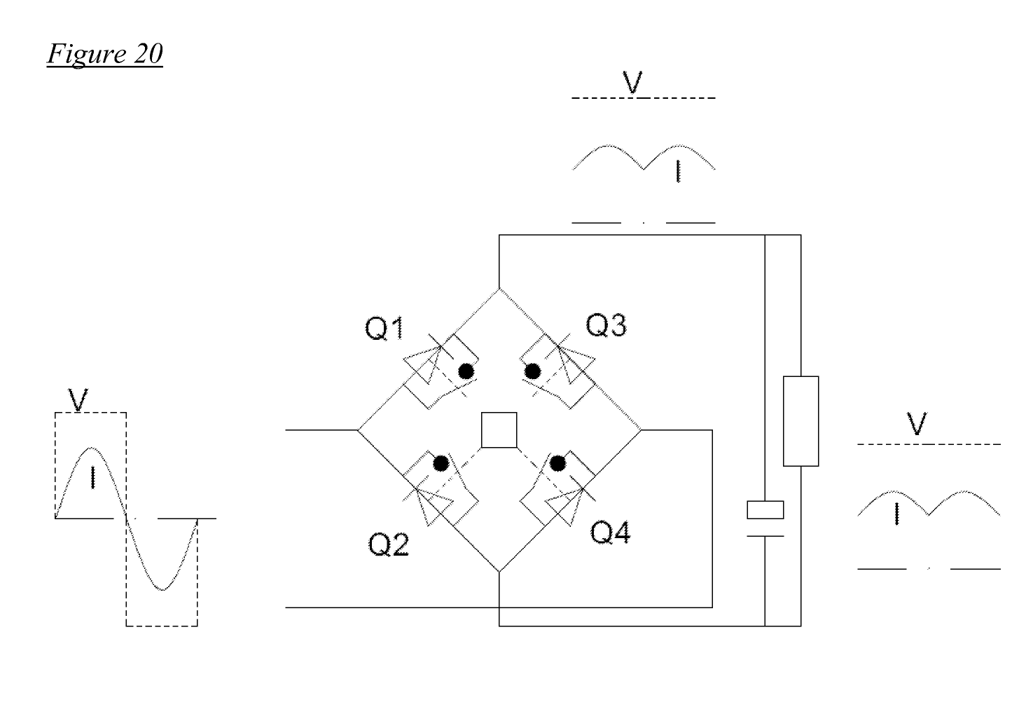

FIG. 20 is a schematic illustration of the rectifier circuit of FIGS. 9a, 9b, 10a and 10b, during normal operation;.

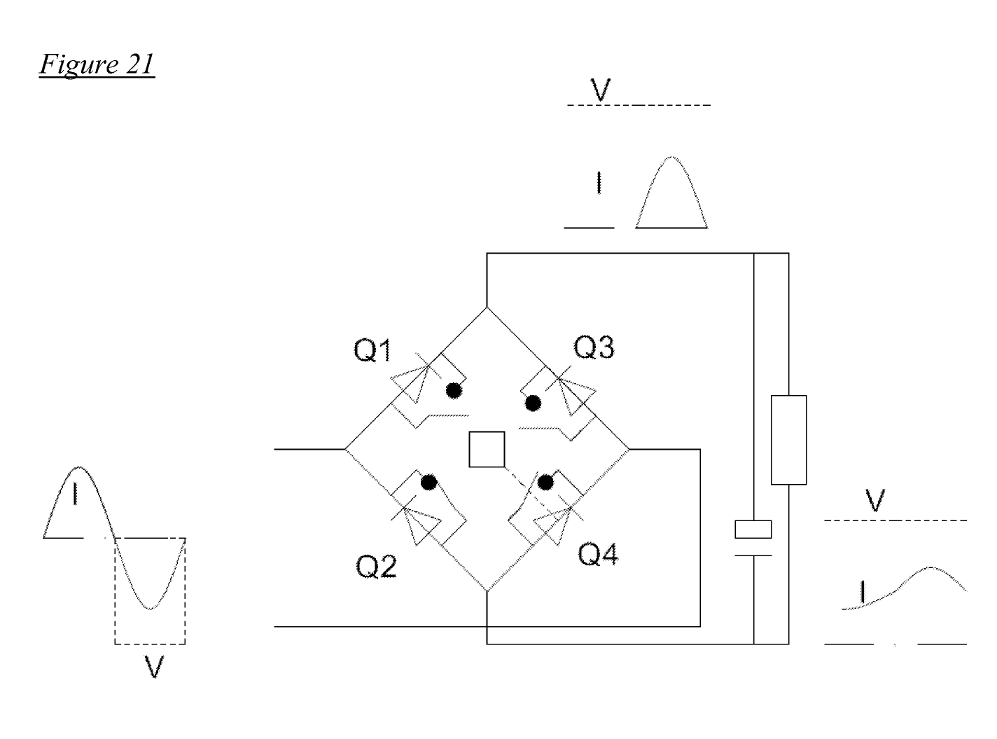

FIG. 21 is a schematic illustration of the rectifier circuit of FIGS. 9a, 9b, 10a and 10b, in a half power mode;

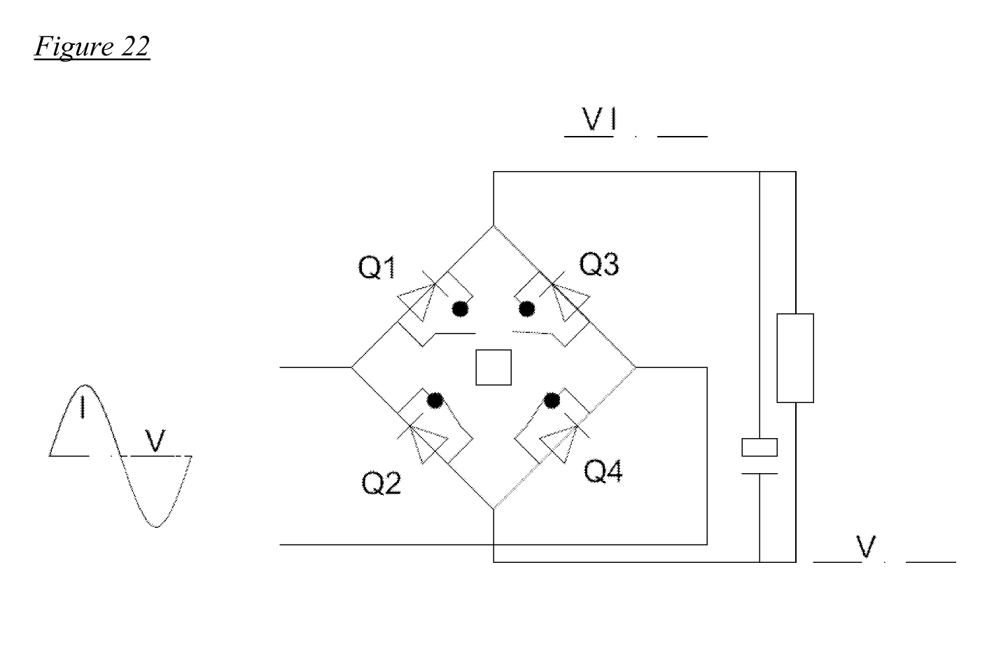

FIG. 22 is a schematic illustration of the rectifier circuit of FIGS. 9a, 9b, 10a and 10b, in a zero power mode; and

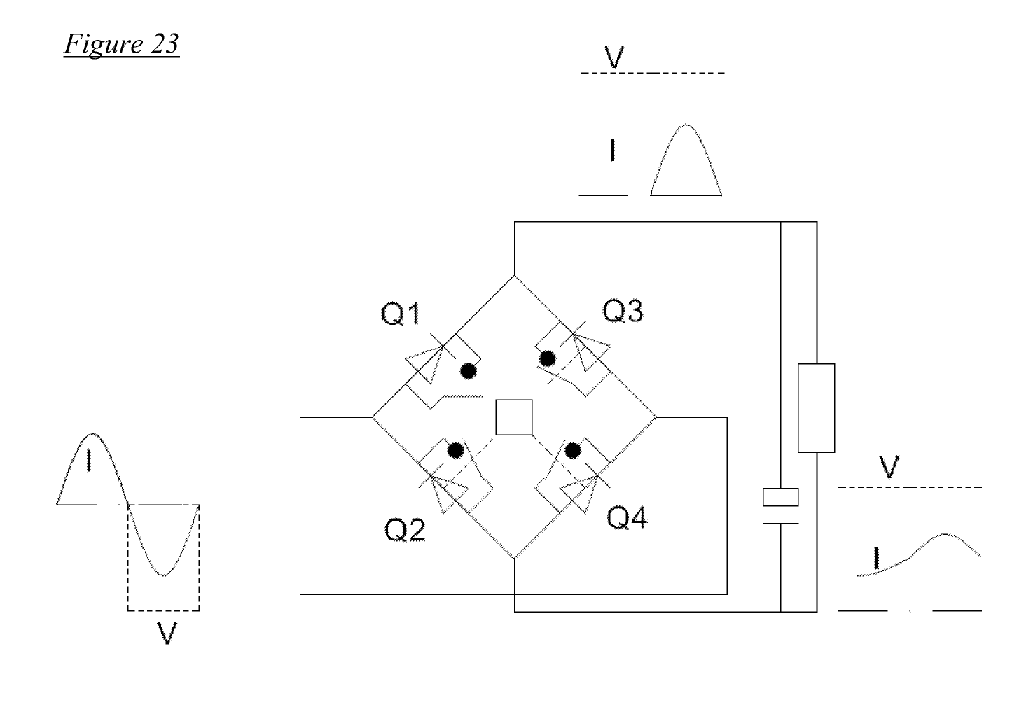

FIG. 23 is a schematic illustration of the rectifier circuit of FIGS. 9a, 9b, 10a and 10b, in the positive half-cycle of a high efficiency half power mode.

FIG. 1 shows a conventional full-wave rectifier bridge, which is adapted to receive an AC voltage at its input, and provide a full-wave rectified DC voltage at its output. This circuit is shown with conventional silicon diodes, but these could be replaced by more expensive Schottky diodes, which have a lower forward voltage.

A disadvantage of this conventional diode bridge is that there is a forward voltage drop (V_{f}) of two diodes between the input and the output of the rectifier circuit. With conventional silicon diodes, this voltage drop is likely to be around 1.5-3.0V. Even with more expensive Schottky diodes, the voltage drop is likely to be around 0.3-0.9V.

FIG. 2 shows a rectifier circuit according to a first embodiment of the invention, which is adapted to provide full-wave rectification, but with a negligible voltage drop between its input (TB1-1 and TB1-2) and output (TB2-1 and TB2-2). In particular, each diode of the conventional diode bridge has been replaced by an enhanced mode MOSFET (Q1A,Q1B,Q2A,Q2B).

The four MOSFETs are connected to conduct in opposing pairs. The pair of MOSFETs that is conducting is dependent upon the polarity of the input voltage. The conducting pairs of MOSFETs are arranged to steer the input voltage to the appropriate output terminals so as to always maintain the same polarity at the output, in a similar manner to the arrangement of a conventional diode bridge.

Each enhanced mode MOSFET has an intrinsic body diode, when the MOSFET is turned off. These intrinsic diodes are shown in FIG. 2. The MOSFETS are connected with the intrinsic diodes having the configuration of a conventional full-wave rectifier bridge.

The MOSFETs are each arranged to conduct electric current between a particular input terminal and a particular output terminal of the rectifier circuit. The gate of each MOSFET is connected to the other input terminal, ie the input terminal from which electric current is not conducted to an output terminal by that MOSFET.

The circuit also includes four zener diodes, which are connected between the gate of each MOSFET and the associated input terminal. These zener diodes enable the rectifier circuit to handle a higher voltage range, and will be described in more detail below. Initially, the low voltage configuration will be described, which is achieved by connecting TP1A to TB1-2, TP2A to TB1-1, TP1B to TB1-1 and TP2B to TB1-2, such that the zener diodes are by-passed.

In the low voltage configuration, when voltage is first applied, the circuit acts as a diode bridge. In particular, the pair of MOSFETs arranged to conduct the polarity of the input voltage will act as diodes until the input voltage charges the gate capacitors of the MOSFETs, and hence turns on the MOSFETs. A forward voltage drop of two diodes will therefore appear during this stage. For this reason, the MOSFETs are selected to have low gate capacitances, such that the charging of the gate capacitors takes only a few nanoseconds.

Once the appropriate pair of MOSFETs have been turned-on, these MOSFETs will have a conducting channel that will effectively by-pass their intrinsic body diodes. The voltage drop will then be a function of the drain-to-source resistance of the conducting MOSFETs, which is typically very low, and certainly much lower than the forward voltage drop of a diode.

When the polarity of the input voltage reverses, the other pair of MOSFETs will be turned on, and will also pass through the diode and conducting stages described above.

Hence, other than during the period in which the gate capacitances of the appropriate pairs of MOSFETs are charged, which is very short indeed, the voltage drop will be a function of the drain-to-source resistance of the conducting MOSFETs, which is typically very low. The problem of voltage drop in rectifier circuits is therefore substantially eliminated by this configuration of the rectifier circuit.

The low voltage configuration of the rectifier circuit is only suitable for use with an input voltage that does not exceed the gate-to-source voltage (V_{GS}) rating of the MOSFETs, which is normally around 18-20V. Hence, the low voltage configuration of the rectifier circuit may be adapted for use with input voltages of 4.5-18V, for example.

The high voltage configuration of the rectifier circuit is achieved by disconnecting TP1A from TB1-2, TP2A from TB1-1, TP1B from TB1-1 and TP2B from TB1-2, such that the by-pass of the zener diodes is removed. In particular, in this configuration, a zener diode is connected between the gate of each MOSFET and the associated input terminal.

In this high voltage configuration, the zener diode applies a pre-determined voltage drop between the gate of each MOSFET and the associated input terminal, whilst the gate capacitance of the MOSFET is charged during activation of the MOSFET. This pre-determined voltage drop enables a higher input voltage, without exceeding the gate-to-source voltage (V_{GS}) rating of the MOSFET. For example, where each zener diode provides a pre-determined voltage drop of 12 V, the addition of zener diodes would increase the range of acceptable input voltages by 12V, for example from 4.5-18V to 16.5 to 30V. Higher voltage ranges could be accommodated with higher zener voltages.

Once a MOSFET has been activated, and hence the gate capacitance has been charged, the voltage drop across the zener diode will be removed, as will the voltage drop across the intrinsic body diodes of the MOSFETs. For this reason, the MOSFETs are selected to have low gate capacitances, such that the charging of the gate capacitors takes only a few nanoseconds.

Hence, other than during the period in which the gate capacitances of the appropriate pairs of MOSFETs are charged, which is very short indeed, the voltage drop will be a function of the drain-to-source resistance of the conducting MOSFETs, which is typically very low. The problem of voltage drop in rectifier circuits is therefore substantially eliminated by this configuration of the rectifier circuit.

It is envisaged that the rectifier circuit shown in FIG. 2 would be embodied in an integrated circuit with eight pins, two pins for the AC input (TB1-1,TB1-2), two pins for the DC output (TB2-1,TB2-2), and four control pins (TP1A,TP1B,TP2A,TP2B). Hence, a single chip could be used for a low voltage range of input voltages by connecting the control pins (TP1A,TP1B,TP2A,TP2B) to the input pins (TB1-1,TB1-2), as described above, or alternatively for a high voltage range of input voltages by leaving the control pins (TP1A,TP1B,TP2A,TP2B) disconnected.

The rectifier circuit of FIG. 2 is particularly suitable for use in the supply of power to a solid state light source, such as one or more LEDs, for example as an output stage of a power adaptor for a solid state light source. In this application, indeed in many other applications, it is preferable to smooth the DC output, for example to reduce the peak current.

FIG. 3 shows an output circuit that forms part of a second embodiment of a rectifier circuit according to the invention. The output circuit comprises a Schottky diode (D3) connected between a first output terminal (TB2-1) of the circuit of FIG. 2 and an associated output terminal (+) of the output circuit, and a direct connection between a second output terminal (TB2-2) of the circuit of FIG. 2 and an associated output terminal (0V) of the output circuit. In addition, the output circuit includes an output capacitor (C1) that is connected across the output terminals (+,0V).

The capacitor (C1) of the output circuit acts to smooth the DC output of the circuit of FIG. 2, and reduce the peak current when connected to one or more LEDs. The inclusion of the Schottky diode (D3) is necessary in order to prevent the output capacitor (C1) discharging as the input voltage falls during each AC cycle. In particular, unlike the diodes of a conventional diode bridge, the MOSFETs of the rectifier circuit do not prevent reverse current flow once activated.

Although the inclusion of a Schottky diode (D3) introduces a voltage drop into the rectifier circuit, this voltage drop is across one diode only, rather than across two diodes, as would be the case in a conventional diode bridge. Furthermore, only one relatively expensive Schottky diode (D3) is needed, rather than the four needed for an efficient diode bridge, thereby significantly reducing manufacturing costs.

As an alternative, the Schottky diode (D3) could be replaced by a single synchronous rectifier diode, which may comprise a MOSFET that is turned on when current is flowing into the output capacitor (C1), but turned off when current is flowing in the other direction.

FIG. 4 shows a rectifier circuit according to a third embodiment of the invention. This circuit is similar to the first embodiment, as shown in FIG. 2, but the p-channel MOSFETs (Q1A and Q1B), which where connected between each input terminal and the positive DC output terminal TB2-1 in the first embodiment, have each been replaced by a Schottky diode (D3A,D3B). The presence of the Schottky diodes enables an output capacitor to be connected across the output terminals (+,0V), without any need for a Schottky diode at the output, as in the second embodiment.

This circuit therefore includes a voltage drop across one MOSFET and one diode only, rather than across two MOSFETs and one diode, as in the second embodiment. Furthermore, this embodiment requires less components than the second embodiment, which may reduce manufacturing costs.

This circuit may also be arranged with two p-channel MOSFETs, and two diodes (replacing the n-channel MOSFETs of the circuit of FIG. 2). However, the circuit shown in FIG. 4 would typically be preferable in view of the generally lower cost and/or higher efficiency of n-channel MOSFETs.

FIG. 5 shows a rectifier circuit according to a fourth embodiment of the invention. This circuit has been adapted to remove the need for a diode at the output (see second embodiment) or diodes in the bridge (see third embodiment) when an output capacitor is connected across the output terminals (+,0V).

This circuit has a similar configuration to the circuit of the first embodiment (see FIG. 2). However, rather than the gates of the n-channel MOSFETs being connected to an input terminal either directly, or via a zener diode, the gates of the n-channel MOSFETs are connected to a monostable circuit that provides a one-shot timed waveform to activate the MOSFETs.

This circuit is adapted to control the n-channel MOSFETs to only allow flow of current from the negative output terminal in the direction of the respective input terminals, through the n-channel MOSFETs, and hence prevent discharge of an output capacitor connected across the output terminals.

The logic gates are adapted to cause the monostable circuit to be triggered by the input to the circuit, and direct the one-shot, timed waveform to the n-channel MOSFET that would have received a gate signal from an input terminal in the arrangement of the first embodiment. This arrangement enables the circuit to have a single monostable circuit.

The logic gate arrangement therefore receives inputs from the respective input terminals and an input from the monostable circuit. In this embodiment, the logic gates are connected to the respective input terminals via zener diodes. A zener diode is also used to provide a pre-determined voltage supply to the monostable circuit. The logic circuit is therefore adapted to provide a pre-determined voltage drop between the gate of each MOSFET and the associated input terminal, whilst the gate capacitance of the MOSFET is charged during activation of the MOSFET. This pre-determined voltage drop enables a higher input voltage, without exceeding the gate-to-source voltage (V_{GS}) rating of the MOSFET.

In addition, the one-shot, timed waveform is timed to be shorter than the period of the input cycle during which the flow of current through the n-channel MOSFET is from the negative output terminal in the direction of the appropriate input terminal.

The n-channel MOSFET is therefore turned off by the monostable circuit before the direction of current is reversed, thereby preventing discharge of the output capacitor.

This circuit may also be arranged with the two p-channel MOSFETs being the

MOSFETs that are controlled by the monostable circuit. However, the circuit shown in FIG. 5 would typically be preferable in view of the p-channel MOSFETs having the higher gate voltage, which may therefore remove the need for zener diodes for those gate connections.

The rectifier circuits discussed above are particularly suitable for use in the supply of power to a solid state light source, such as one or more LEDs, for example as an output stage of a power adaptor for a solid state light source.

FIG. 6 shows a first embodiment of a power adaptor 20 according to the invention. The power adaptor 20 comprises an input 22 for drawing electrical power from a mains circuit, and an output 24 for providing electrical power to LEDs 70a,70b,70c of a solid state lighting unit 60 (shown in FIG. 8). The power adaptor 20 includes a conventional filtering and rectifying circuit 30 at the input 22, such that the AC voltage waveform drawn from the mains circuit is supplied to the remainder of the power adaptor circuitry as a full-wave rectified waveform (DC+).

The power adaptor 20 also includes a low power, auxiliary power supply 32, and a resonant circuit 34 including a resonance controller 40 and a resonance drive circuit 42, which are described in more detail below with reference to FIG. 7.

The resonant circuit 34 also includes one of the second, third and fourth embodiments of the rectifier circuit according to the invention at its output. This rectifier circuit is designated by reference numeral 50 in FIG. 7.

The low power, auxiliary power supply 32 provides a low power DC output (+V) for powering the integrated circuits of the resonance controller 40, the resonance drive circuit 42 and the rectifier circuit 50. This provides a stable power supply to the integrated circuits of the power adaptor to ensure stable functioning of those circuits. It is noted that in other embodiments, the integrated circuits of the power adaptor are powered by connections to additional windings coupled to one of the inductors of the resonant circuit, and hence the auxiliary power supply 32 is omitted.

The resonant circuit 34, including the resonance controller 40, the resonance drive circuit 42 and the rectifier circuit 50, is shown in FIG. 7. The resonance controller 40 includes a control circuit and is adapted to control the resonance drive circuit 42. In particular, the resonance controller 40 has an output for supplying a control signal to the resonance drive circuit 42, which determines the form of the current drawn from the input by the resonant circuit 34. It is noted that in other embodiments, the resonance drive circuit 42 is self-oscillating, and the control circuit is omitted altogether.

The resonant circuit 34 has the form of an LCL series-parallel resonant circuit (L1, C1 and L2). The LCL series-parallel resonant circuit has a first terminal and second terminal connected to a half bridge inverter with two electronic switching devices (eg FETs) and voltage dividing capacitors (C2 and C3). A first inductor L1, and first capacitor C1 are connected in series from the first terminal to the second terminal. The load leg of the circuit is connected in parallel with the first capacitor C1, the load leg comprising a second inductor L2 in series with the rectifier circuit 50 to supply unidirectional current to the LEDs 70a,70b,70c of the solid state lighting unit while current in the resonant circuit alternates at high frequency.

The resonance drive circuit 42 is adapted to drive the LCL series-parallel resonant circuit with a square wave driving signal. This square wave signal is generated by the two electronic switching devices, eg FETs, connected to a first end of the resonant circuit, and associated drive circuitry 44. The FETs are controlled by the resonance controller 40. The voltage dividing capacitors C2 and C3 create a connection point for the second end of the resonant circuit, substantially midway in voltage between DC+ and 0V.

As discussed above, the output of the resonant circuit 34 is rectified by the rectifier circuit 50, so as to form an output suitable for driving the LEDs 70a, 70b, 70c of the solid state lighting unit. Since the rectifier circuit 50 results in a voltage drop over a single Schottky diode only, the rectifier circuit 50 enables a significant increase in efficiency relative to a conventional full-wave rectifier bridge, and also reduces the number of relatively expensive Schottky diodes to one.

The LCL series-parallel resonant circuit is configured such that at a chosen frequency, the reactance of L1 (X_{L1}), the reactance of C1 (X_{C1}) and the reactance of L2 (X_{L2}) are substantially equal. In this configuration, the LCL series-parallel resonant circuit has two non-zero resonant frequencies. The frequency at which the reactances are equivalent will be one of the two non-zero resonant frequencies. When driving the resonant circuit at this frequency, the resonant circuit supplies a constant current to the output, and hence to the LEDs 60a,60b,60c, regardless of the load. The magnitude of the constant current is proportional to the input voltage. This resonant frequency is

$${ω}_{1} = + \frac{1}{\sqrt{{L}_{S} {C}_{P}}} \qquad ( 2 )$$

The resonance controller 40 and the resonance drive circuit 42 is therefore adapted to excite the LCL series-parallel resonant circuit close to this resonant frequency, ω₁. As a consequence of driving the resonant circuit close to the resonant frequency, the switching losses in the electronic switches are reduced, and hence the efficiency of the circuit is improved. Further advantages include the reduction of conducted and radiated electromagnetic interference, and hence the reduction of the expense of necessary filtering and screening components.

A fault detection circuit is preferably provided that includes a connection between the output of the LCL series-parallel resonant circuit and a disable pin on the PIC of the resonance controller 40, through resistor R1, and a connection with 0V through resistor R2. The fault detection circuit draws minimal power. However, in the event that an LED 70a,70b,70c stops conducting, the associated fault detection circuit quickly detects a rise in voltage at the output of the resonant circuit and causes the resonance controller 40 to shut-off its output to the resonant drive circuit 42, and hence cause the drive signal to be removed from the resonant circuit 34. In FIG. 7, the fault detection circuit is shown connected to the connection between L2 and the rectifier circuit 50. However, please note that this circuit could also be connected to the connection between the positive end of the rectifier circuit 50 and the positive terminal of the output 24.

The power adaptor is adapted to connect to a high voltage power supply (eg 110V or 230V AC, at frequencies of 50Hz or 60Hz), such as a mains supply, and provide an output suitable for driving a low voltage load, such as a solid state light source (eg 10-20V). The amount of power delivered to the LEDs 60a,60b,60c can be varied with the variation of the input mains supply voltage, which makes it suitable for use with a power reducing device 10 (shown in FIG. 8).

FIG. 8 shows a lighting system according to the invention. The lighting system is connected to a mains circuit including a mains supply L,N and a power reducing device 10, such as a TRIAC, and comprises a power adaptor 20 according to the invention and a solid state lighting unit 60. The solid state lighting unit 60 comprises three LEDs 70a, 70b, 70c connected in series. The power adaptor 20 is supplied with electrical power from the mains circuit, and is adapted to provide electrical power to the LEDs 70a, 70b, 70c of the solid state lighting unit 60.

FIGS. 9a, 9b, 10a and 10b show a rectifier circuit according to a fifth embodiment of the invention. This circuit is similar to the rectifier circuit according to a fourth embodiment of the invention, as shown in FIG. 5, in that the gates of the n-channel MOSFETs Q2, Q4 are each connected to a monostable circuit U1E, U2E that provides a one-shot timed waveform to activate the MOSFETs. This circuit is adapted to control the n-channel MOSFETs Q2, Q4 to only allow flow of current from the negative output terminal in the direction of the respective input terminals, through the n-channel MOSFETs, and hence prevent discharge of an output capacitor connected across the output terminals. This circuit therefore removes the need for a diode at the output (see second embodiment) or diodes in the bridge (see third embodiment) when an output capacitor is connected across the output terminals (+,0V).

This rectifier circuit, however, differs in a number of respects from the fourth embodiment. Firstly, rather than having zener diodes in series with the gates connections of the MOSFETS, this circuit has a voltage regulator (transistor Q6, resistor R3 and zener diode D9) that provides power to the logic arrangement. In addition, the logic arrangement is AC-coupled to the respective input terminals by C2 and C5, which are 47 pF, 50V-rated, capacitors, such that the logic arrangement detects the leading edges of the AC input.

As shown in FIGS. 9a and 9b, the logic arrangement includes a leading edge time delay, which ensures that there are no unintentional short-circuit conditions, as well as a portion of the logic arrangement that determines the time period over which the n-channel MOSFETs Q2, Q4 are activated. The duration of this time period is set using capacitor C1.

This rectifier circuit also includes protection against an open circuit condition. In particular, as discussed above, the rectifier circuit according to the invention is particularly advantageous in relation to power adaptors comprising an LCL series-parallel resonant circuit. In these embodiments, an open circuit condition would cause a catastrophic failure of the LCL resonant circuit, and would also cause the voltage in the rectifier circuit to rise above normal operating voltages. However, a short circuit condition at the input side of the rectifier circuit does not have any negative effect on the LCL resonant circuit, due to the constant current supplied by the LCL resonant circuit and the lack of any potential difference between the output terminals of the LCL resonant circuit in this configuration. A short on the output side of the rectifier circuit, and a short between the input and the output, must nevertheless be avoided due to the large currents that can occur in these configurations.

Since an open circuit condition would cause the output of the rectifier circuit to rise above normal operating voltages, the rectifier circuit is adapted to detect an increase in the voltage in the rectifier circuit above a pre-determined level. This is achieved by U1D, which turns on if the output voltage reaches 28.6 V. This voltage is determined by D2, a zener diode with a pre-determined voltage drop of 28V that is connected to the output (X2) of the rectifier circuit, as well as R9 and C6.

In the event that an over-voltage condition is detected, and hence U1D is turned on, the rectifier circuit is adapted to create a short circuit condition across the input terminals of the rectifier circuit, which prevents the output voltage increasing to a level where either the LCL resonant circuit or the rectifier circuit is damaged. In particular, U1D being turned on causes MOSFETs Q2 and Q4 to be activated and held active, via U1B and U1C, and also causes MOSFETs Q1 and Q3 to be deactivated and held inactive, using disable MOSFETs Q11 and D33. This causes the input terminals to be connected, and hence the power output of the LCL series-parallel resonant circuit to fall to zero, without any short across the output terminals.

Since the power output of the LCL series-parallel resonant circuit falls to zero, C6 is provided to keep U1D turned on, and hence MOSFETs Q2 and Q4 active and MOSFETs Q1 and Q3 inactive. Once C6 has discharged, U1D will be turned off, and the rectifier circuit will return to its normal operating configuration. If the open circuit condition has been removed, the rectifier circuit will continue in its normal operating configuration. However, in the event that an over-voltage condition is once again detected, and hence U1D is once again turned on, the rectifier circuit will return to the short-circuit condition, as discussed above, and this cycle will continue until the open circuit condition is removed.

This rectifier circuit also includes an arrangement for temporarily deactivating the n-channel MOSFETs when the mains input voltage to the LCL resonant circuit is low, in each mains cycle. This is done because the input to the rectifier circuit is low and distorted when the mains input voltage to the LCL resonant circuit is low, in each mains cycle, which may cause the n-channel MOSFETs (Q2 and Q4) to go out of sync with the p-channel MOSFETs (Q1 and Q3), thereby causing a short between the input and output terminals. This temporary deactivation of the n-channel MOSFETs causes the intrinsic diodes of the MOSFETs to form a conventional diode bridge at low voltages, in each mains cycle.

This deactivation arrangement comprises a connection to DC+ of the LCL resonant circuit (see FIG. 7), which comprises two high ohmic resistors R11 and R12 (see FIG. 9a). A zener diode D10 and resistors R7 and R77 are also provided, which provide a reference to ground in the rectifier circuit, and feed logic gate U2C.

If the voltage of DC+ is high, the output of U2C will be high, and the n-channel MOSFETs Q2 and Q4 will be activated. However, when the mains input voltage to the LCL resonant circuit is low, in each mains cycle, and hence the voltage of DC+ is low, the output of U2C will be low, and the n-channel MOSFETs Q2 and Q4 will be deactivated. The n-channel MOSFETs Q2 and Q4 are therefore deactivated during that portion of each mains cycle that DC+ of the LCL resonant circuit is below a pre-determined voltage.

This rectifier circuit also includes an arrangement for providing half power output when the peak voltage at the mains input is above a pre-determined reference voltage, whilst maintaining maximum efficiency. In particular, a comparator U3 is provided that acts to keep MOSFET Q2 turned on, via U1A and U1C, when the peak voltage at the mains input is above a pre-determined reference voltage, but enable MOSFET Q2 to be activated as normal when the peak voltage at the mains input is below the pre-determined reference voltage. In particular, the connection to DC+ in the LCL resonant circuit feeds pin 2 of the comparator U3. When the voltage at pin 2 of the comparator U3 rises above a pre-determined reference voltage, the output of the comparator U3 goes low, activating MOSFET Q2, via U1A and U1C. In addition, the output of the comparator U3A going low causes MOSFET Q4 to be turned off, via D8, U2C and U1B.

When MOSFET Q2 is activated as normal, the output from the rectifier circuit will be at full power. When the comparator U3 acts to keep MOSFET Q2 turned on, the input terminals are shorted during the half of the high frequency resonant cycle at the input in which MOSFET Q4 is activated. Since the LCL series-parallel resonant circuit is adapted to provide a constant current output, and the shorting of the input terminals causes the output voltage of the resonant circuit to fall to zero, the power output of the resonant circuit, and hence the power output of the rectifier circuit, during this half of the high frequency resonant cycle is zero. In the other half of the high frequency resonant cycle, the rectifier circuit will transfer power to the output as normal. Hence, the control circuit will cause half power to be supplied to the output whenever the peak voltage at the mains input is above a pre-determined reference voltage.

MOSFET Q1 is turned off using MOSFET Q11, when MOSFET Q2 is turned on, in order to prevent a short-circuit across the output terminals, rather than the input terminals, which may cause large currents.

This arrangement for reducing the power is particularly advantageous when used with an LCL series-parallel resonant circuit because the power adaptor is protected from high peak voltages in the mains input, without directly controlling the LCL resonant circuit, which may result in significant efficiency losses and/or RFI problems. In addition, since the output is not turned off, the input of the power adaptor will continue to draw current from the mains, which helps maintain the current drawn by the resonant circuit when driven by an external TRIAC. There is also no noticeable increase in light flicker, and this arrangement helps maintain harmonic compliance and good power factor.

FIG. 19 is a schematic diagram of a rectifier circuit in which each MOSFET is controlled by a direct connection to an input terminal (indicated by the short broken line extending from the body diode), and there is no control of the MOSFETs to prevent discharge of the output capacitor. The input shown is that provided by an LCL resonant drive circuit, when a load is connected.

Several different modes of a rectifier circuit according to the invention, in the arrangement of FIGS. 9a, 9b, 10a and 10b, are illustrated in the table below and in FIGS. 20-23.

| Mode | | Q1 | Q2 | Q3 | Q4 | Figure |
|---|---|---|---|---|---|---|
| Normal operation | | DD | MP | DD | MP | 20 |
| Half power output | | o\c | s\c | o/c | MP | 21 |
| Half power output | Positive | o/c | Extra MP | DD | MP | 23 |
| (high efficiency) | Negative | o\c | MP | DD | MP | 23 |

| | | | | | |
|---|---|---|---|---|---|
| No power output | o\c | s\c | o\c | s\c | 22 |

DD = MOSFET is controlled by a direct connection to an input terminal
MP = MOSFET is controlled by a timed activation, eg a monstable pulse
o\c = MOSFET is held “open-circuit”, ie deactivated, such that only the body diode conducts
s\c = MOSFET is held “short-circuit”, ie activated, such that only the body diode is by-passed, ie shorted

In FIGS. 20-23, control by connection to an input terminal is indicated by a short broken line extending from the body diode, and control by monostable pulse is indicated by a broken line extending from the body diode and terminating at a central box. Open-circuit and short-circuit states are indicated by open and closed positions of the switch symbols, respectively.

The modes of (i) normal operation, (ii) no power output and (iii) half power output are described in detail above in relation to the circuit shown in FIGS. 9a, 9b, 10a and 10c. In particular, in normal operation, Q1 and Q3 are controlled by direct connections to input terminals, and Q2 and Q4 are controlled by a mono stable pulse that ensures that the output capacitor is not discharged through the diode bridge.

In the “no power output” mode, Q2 and Q4 are both activated and kept active to maintain a short-circuit condition across the input terminals. In addition, Q1 and Q3 are deactivated and kept deactivated while the short-circuit condition is present, in order to prevent the creation of a short-circuit across the output terminals.

In the “half power output” mode, Q2 is activated and kept activated in order to provide a short-circuit condition in the positive half-cycle. In addition, Q1 is deactivated and kept deactivated in order to prevent the creation of a short-circuit across the output terminals.

The mode of half power output (high efficiency) is the same as the half power output mode, save for the Q3 being activated in the negative half of the input cycle, in order to provide efficient transfer of power in the half cycle in which the short-circuit condition is not present. This is most conveniently achieved by Q3 being activated by a direct connection to the input terminal. In addition, Q2 is activated by a monostable pulse in both the positive and negative half cycles.

FIG. 11 is a schematic diagram of a second embodiment of a power adaptor according to the invention. The power adaptor comprises an AC mains input 110, an input rectifier 120, a combined snubber and auxiliary supply 130, a control circuit 140, a discharge circuit 150, a drive circuit 160, and an output 170.

The AC mains input 110 is adapted for connection to an AC mains supply, with or without an electrical dimmer, that forms part of a lighting system. In conventional lighting systems, the electrical dimmer will typically include a TRIAC, which is bypassed by a capacitor and has an inductor in series with its output. The output 170 of the power adaptor is adapted for connection to a solid state light source, eg an LED or a string of LEDs in series.

The input rectifier 120 (see FIG. 12) includes an input inductor L1 and a bridge rectifier DB1 for providing DC power (DC+, 0VM) to the power adaptor. The combined snubber and auxiliary supply 130 (see FIG. 13) is primarily a snubber circuit for preventing variation of the current, ie “ringing”, that would otherwise be caused by the input inductor L1 feeding the drive circuit 160. In particular, this ensures that a sufficiently continuous current is drawn from the AC mains supply to keep the TRIAC of the electrical dimmer turned on. In addition, the combined snubber and auxiliary supply 120 is adapted to supply low voltage DC power (VCC) to the Programmable Integrated Circuit U1 (the “PIC” U1) of the control circuit 140.

The control circuit 140 (see FIG. 14) is adapted to control the drive circuit 160 of the power adaptor, such that the output of the drive circuit 160 is suitable for driving an LED following rectification by the rectifier circuits discussed above. In particular, in this embodiment, the drive circuit 160 (see FIG. 16) includes an

LCL series-parallel resonant circuit, as discussed above in relation to the first embodiment of the power adaptor and disclosed in WO 2008/120019 A1, and an output 110 that feeds the rectifier circuits discussed above. The PIC U1 of the control circuit 140 therefore includes electronic switches, such as two FETs, that provide an oscillating signal (eg a square wave driving signal) to the drive circuit 160, at the desired frequency to drive the LCL series-parallel resonant circuit.

The discharge circuit 150 (see FIG. 15) is adapted to ensure that the control and drive circuits 140,160 remain inactive, and hence no power is provided to the output 170, when the electrical dimmer is switched off, but nevertheless supplies a small current to the power adaptor. This is a particular problem with conventional electrical dimmers that include TRIACs.

The discharge circuit includes a load resistor R10 and a FET Q1 connected in series to the input side of the bridge rectifier DB1, via diodes D11 and D12. The gate voltage of FET Q1 is provided by a resistor R11 and FET Q2 connected in series to the low voltage output (VCC) of the combined snubber and auxiliary supply 130. FET Q1 is therefore turned on when the voltage output (VCC) of the combined snubber and auxiliary supply 130 is sufficient. Furthermore, the gate voltage of FET Q2 is provided by a connection to the PIC U1 of the control circuit 140, such that FETs Q1 and Q2 are turned off when the oscillator of the PIC U1 is running.

The power adaptor is configured such that the load resistor R10 is energised when the voltage output (VCC) of the combined snubber and auxiliary supply 30 is sufficient, via R11, to turn on FET Q1, but the load resistor R10 is de-energised when the voltage output (VCC) supplied to the PIC U1 is sufficient for the oscillator to run. The voltage sufficient to turn on FET Q1 is less than the voltage sufficient for the oscillator to run.

Hence, when the electrical dimmer is switched off, but nevertheless supplies a small current to the power adaptor, the load resistor R10 will become energised when the voltage output (VCC) of the combined snubber and auxiliary supply 130 reaches a level sufficient for FET Q1 to be turned on. However, this voltage level will be less than the level required for the oscillator of the PIC U1 to run. Once energised, the load resistor R10 will remain energised until the voltage output (VCC) of the combined snubber and auxiliary supply 30 has decreased below the gate voltage of Q2. The discharge circuit 50 will therefore intermittently discharge power from the power adaptor, and in particular will drain power from the mains input to the input rectifier 120 or the DC link capacitors (C5,C6) of the drive circuit 160, such that the control and drive circuits 40,60 are not activated when the electrical dimmer is switched off. The discharge circuit therefore prevents the intermittent flickering that would otherwise occur when the electrical dimmer is switched off.

When the power adaptor is connected to an AC mains supply without an electrical dimmer, or alternatively the electrical dimmer of the AC mains supply is at full power, FET Q1 will remain turned off, such that no power is discharged through the load resistor R10. In particular, as discussed above, FET Q1 only turns on when the oscillator in the PIC U1 stops running. Furthermore, the gate voltages of the FETs Q1, Q2 are not provided by connections to the DC output (DC+, 0VM) of the input rectifier 120, which would cause power to be lost through the resistors of such connections. Hence, at full power, the discharge circuit does not cause significant power losses, and hence maintains the power adaptor at its optimum efficiency.

During normal operation, the load resistor R10 is deactivated before the mains input reaches a level that could damage the components of the discharge circuit 150. However, a connection is also provided between the mains input of the input rectifier 120 and the gate of FET Q2. This connection acts to turn on FET Q2, and hence turn off FET Q1 and deactivate the load R10, when the mains input reaches around 30% of full mains voltage. This connection would therefore deactivate the discharge circuit 150 in the event that the power adaptor is connected to a main supply of incorrect voltage, or the PIC U1 is malfunctioning and does not start, for example, in order to prevent damage to the components of the discharge circuit 150.

Although this connection acts to deactivate the discharge circuit 150 when the mains input reaches a particular level, this connection is different to prior art arrangements that rely on a connection along these lines to deactivate the discharge circuit during normal operation. In particular, these prior art arrangements must deactivate the discharge circuit at a much lower low level, eg 3% of full mains voltage, than the connection of the present invention, which deactivates the discharge circuit 150 when PIC U1 is running. The present invention is therefore compatible with a greater range of dimmers than prior art arrangements.

When the power adaptor receives a chopped waveform from the electrical dimmer, and hence the electrical dimmer is switched on, but is providing less than 100% power to the power adaptor, the load resistor R10 will generally be energised during the OFF potion of the mains cycle, and will generally be de-energised during the ON portion of the mains cycle.

This is achieved by providing a voltage output (VCC) of the combined snubber and auxiliary supply 130 that decays sufficiently quickly during the OFF potion of the mains cycle for the oscillator of the PIC U1 to stop running, but sufficiently slowly for the load resistor R10 to remain energised throughout the OFF potion of the mains cycle. In particular, when the mains cycle enters its OFF portion, the oscillator in the PIC U1 stops running, causing FET Q1 to be turned on. As discussed above, FET Q1 is adapted to stay turned on until the voltage output (VCC) of the combined snubber and auxiliary supply 30 decreases below the gate voltage of Q2. However, this decrease in the voltage output (VCC) is adapted to take longer than the 10 ms mains half-cycle by the capacitor C12. FET Q1 will therefore remain turned on during the OFF potion of the mains cycle, until the voltage rises again.

During the voltage rise in the ON portion of each mains cycle, there will be a short time period during which FET Q1 will be turned on, due to the voltage output (VCC) being sufficient to provide the gate voltage, but insufficient to drive the oscillator of the PIC U1. However, this time period will be very short because the voltage will soon rise to the level sufficient to drive the oscillator of the PIC U1, such that FET Q1 is turned off. Indeed, the faster the voltage rise and the greater the final voltage supplied by the AC mains supply, the shorter this time period.

In this regard, the power adaptor includes a zener diode D10 and a resistor R24 in the connection between C12 and VCC, which act as an averaging filter that smooths the on/off transition of PIC U1 of the control circuit 140. This reduces the flicker when the power adaptor is used with dimmers that provide very low power, ie the ON portions of the mains cycle are very short.

In addition, a transistor, Q4, has been added to the combined snubber and auxiliary supply 30, which is arranged to increase the current supplied to the PIC U1 of the control circuit 140 when the PIC U1 is not running, and hence R10 is active. This additional current enables the PIC U1 to be turned on quicker from its standby mode, particularly at low dimmer levels or phase angles.

FIG. 17 is a schematic diagram of an alternative combined snubber and auxiliary supply, and a control circuit, for use with the second embodiment of the power adaptor, as described above.

This circuit differs from the combined snubber and auxiliary supply, and a control circuit, shown in FIGS. 13 and 14 in that a diode D8 has been added, which transfers power from C3 to the DC link capacitors D5 and D6 in the drive circuit (see FIG. 16) when the voltage across C5 and C6 is less than the voltage across C3. Hence, when the mains voltage is low in each mains cycle, D8 acts to transfer power to the drive circuit and maintain an output from the drive circuit. In particular, this arrangement ensures that the voltage across the DC link capacitors D5 and D6 in the drive circuit does not fall below the voltage supply (VCC) of the PIC U1 of the control circuit 140.

The diode D8 therefore reduces current ripple at the output, and hence reduces light flicker when the power adaptor used with a solid state light source, such as an LED. This is illustrated by FIGS. 18a, 18b and 18c. In particular, FIG. 18a is a schematic illustration of an idealised mains input current, FIG. 18b is a schematic illustration of an idealised output current of the power adaptor of FIG. 11, and FIG. 18c is a schematic illustration of an idealised output current of the power adaptor of FIG. 11 when modified in accordance with the arrangement shown in FIG. 17.

Furthermore, where the power adaptor includes a rectifier circuit as described above, this arrangement addresses the problem of the input to the rectifier circuit ordinarily being low and distorted when the mains input voltage to the LCL resonant circuit is low, in each mains cycle, which may cause the n-channel MOSFETs to go out of sync with the p-channel MOSFETs, thereby causing a short between the input and output terminals. In particular, this arrangement maintains the mains input voltage to the LCL resonant circuit at or above a certain level, and hence removes any low and distorted input to the rectifier circuit. This arrangement is therefore an alternative to the temporary deactivation of the n-channel MOSFETs, which causes the intrinsic diodes of the MOSFETs to form a conventional diode bridge at low voltages, in each mains cycle, which is configured in the rectifier circuit of FIGS. 9a and 9b.

In the second embodiment of the power adaptor, the zener diode D2 is selected to provide a suitable supply voltage (VCC, 12V) to the PIC U1. In the alternative arrangement shown in FIG. 17, a voltage regulator REG 1 is provided to supply the PIC U1, which enables the voltage supplied to the DC link capacitors C5 and C6, through diode D8, to be increased by increasing the voltage set by the zener diode D2 to 25V.

Where this arrangement is used in a power adaptor for a solid state light source, there may be an undesirable effect of increasing the output from the rectifier circuit at low dimmer levels. The power adaptor preferably therefore includes means for reducing the power output from the rectifier circuit, such as an arrangement for shorting the input terminals of the rectifier circuit during one half cycle, along the lines of that described above in relation to the circuit of FIGS. 9a 9b, 10a and 10b.

1. A power adaptor comprising an input for connection to an AC power supply, an LCL series-parallel resonant circuit, and a rectifier circuit adapted to receive an alternating current voltage from the LCL series-parallel resonant circuit and provide an output having a rectified output voltage that is suitable for driving a load,
the rectifier circuit comprising input terminals adapted to receive an alternating current voltage, and output terminals adapted to provide an output having a rectified output voltage,
the rectifier comprising a diode bridge in which the diodes are each adapted to be by-passed by a low-impedance path on activation of an associated electronic switching device,
wherein the rectifier circuit is adapted to control activation of one or more electronic switching devices, such that the flow of current relative to one of the output terminals is in one direction only.

2. A power adaptor as claimed in claim 1, wherein the one or more electronic switching devices that are controlled in order to ensure that the flow of current relative to one of the output terminals is in one direction only, is an additional electronic switching device, in addition to the one or more electronic switching devices that by-pass the one or more diodes with a low-impedance path.

3. A power adaptor as claimed in claim 1, wherein the one or more electronic switching devices that are controlled in order to ensure that the flow of current relative to one of the output terminals is in one direction only, are electronic switching devices that by-pass the one or more diodes with a low-impedance path.

4. A power adaptor as claimed in claim 1, wherein each diode of the diode bridge is defined by the intrinsic body diode of an electronic switching device, such that first and second electronic switching devices having first and second diodes are connected to a first output terminal, and third and fourth electronic switching devices having third and fourth diodes are connected to a second output terminal.

5.-6. (canceled)

7. A power adaptor as claimed in claim 1, wherein the rectifier circuit is adapted to activate at least some of the electronic switching devices to control the power provided at the output terminals.

8. A power adaptor as claimed in claim 7, wherein the rectifier circuit is adapted to activate at least some of the electronic switching devices to create at least a temporary short-circuit across the input terminals of the rectifier circuit, such that the power provided at the output terminals is reduced or removed.

9. A power adaptor as claimed in claim 8, wherein the short-circuit across the input terminals of the rectifier circuit is present in both half-cycles of the input to the rectifier circuit, which would cause the output to fall to zero.

10. A power adaptor as claimed in claim 8, wherein the short-circuit across the input terminals of the rectifier circuit is present in only one half-cycle of the input to the rectifier circuit, which would cause the output to fall to approximately 50% of full power.

11. A power adaptor as claimed in claim 9, wherein the rectifier circuit is adapted to activate two of the switching devices that are connected to the same output terminal, and different input terminals, and keep these switching devices activated to maintain the short-circuit condition, and the rectifier circuit is adapted to simultaneously deactivate the switching devices that are connected to the other output terminal, and keep these switching devices deactivated while the short-circuit condition is present, in order to prevent the creation of a short-circuit across the output terminals of the rectifier circuit.

12. A power adaptor as claimed in claim 10, wherein the rectifier circuit is adapted to activate one of the switching devices, and keep this switching device activated during the half-cycle in which the other switching device that is connected to the same output terminal is activated, in order to provide a short-circuit condition in one half-cycle, and the rectifier circuit is adapted to simultaneously deactivate the switching device that is connected to the same input terminal, and keep this switching device deactivated while the short-circuit condition in one half-cycle is present, in order to prevent the creation of a short-circuit across the output terminals of the rectifier circuit.

13. A power adaptor as claimed in claim 7, wherein the switching devices connected to one output terminal are controlled by timed activation, and the switching devices connected to the other output terminal are controlled by a direct connection to an input terminal.

14. A power adaptor as claimed in claim 13, wherein the one or more electronic switching devices that are activated to create the short-circuit condition are controlled by timed activation, and the one or more electronic switching devices that are deactivated while the short-circuit condition is present, in order to prevent the creation of a short-circuit across the output terminals of the rectifier circuit, are controlled by direct connections to an input terminal.

15.-17. (canceled)

18. A power adaptor as claimed in claim 7, wherein the rectifier circuit includes a protection circuit that activates at least some of the electronic switching devices of the rectifier circuit, when a fault condition exists, to create a short-circuit across the input terminals of the rectifier circuit that reduces or removes the power provided at the output terminals.

19.-20. (canceled)

21. A power adaptor as claimed in claim 1, wherein the rectifier circuit is adapted to deactivate at least some of the electronic switching devices of the rectifier circuit, when the magnitude of the voltage at the input terminals of the rectifier circuit is below a particular level in each AC cycle.

22.-25. (canceled)

26. A power adaptor as claimed in claim 1, wherein a timer is provided that drives and/or controls both the LCL series-parallel resonant circuit and activation of one or more of the electronic switching devices.

27. A power adaptor as claimed in claim 26, wherein the timer is a clock of a processor, and the processor drives and/or controls the LCL series-parallel resonant circuit and the one or more electronic switching devices.

28. An integrated circuit comprising a power adaptor as claimed in claims 1.

29.-31. (canceled)

32. A power adaptor as claimed in claim 1, wherein the power adaptor is suitable for driving a solid state light source.

33. A lighting unit suitable for direct connection to a mains supply, the lighting unit comprising a power adaptor as claimed in claim 1 and a solid state light source.

34. A lighting unit as claimed in claim 33, wherein the lighting unit comprises a housing for accommodating the power adaptor and the solid state light source, and a connector for connecting the input of the power adaptor to the mains supply.
